(19) United States
(12) Patent Application Publication
(10) Pub. No.: US 2026/0309311 A1
(43) Pub. Date: Oct. 8, 2026

(54) TUNABLE LASER PHOSPHOR ENGINE WITH ROTATING OPTICAL WEDGE

(71) Applicant: SIGNIFY HOLDING B.V., EINDHOVEN (NL)

(72) Inventors: CHRISTOPH GERARD AUGUST HOELEN, VALKENSWAARD (NL); HUGO JOHAN CORNELISSEN, ESCHAREN (NL); RIFAT ATA MUSTAFA HIKMET, EINDHOVEN (NL)

(21) Appl. No.: 19/482,943

(22) PCT Filed: Apr. 29, 2024
(86) PCT No.: PCT/EP2024/061732

§ 371 Date: Nov. 10, 2025

(30) Foreign Application Priority Data
May 9, 2023 (EP) 23172186.1

(51) Int. Cl. F21V 14/06; F21V 3/04; F21V 5/02; F21V 9/14; F21V 9/32; F21Y 115/00

(52) U.S. Cl. CPC F21V 14/06; F21V 3/049; F21V 5/02; F21V 9/14; F21V 9/32; F21Y 2115/00

(57) ABSTRACT

The invention provides a light generating system (1000) comprising (i) one or more light generating devices (100), (ii) a luminescent material arrangement (2000), (iii) a movable optical element (410), (iv) an actuator (420), and (v) a control system (300), wherein: (A) the one or more light generating devices (100) are configured to generate device light (101); wherein the one or more light generating devices (100) comprise or more of a laser diode and a superluminescent diode; (B) the luminescent material arrangement (2000) comprises a luminescent material (200) configured to convert at least part of the device light (101) received by the luminescent material (200) into luminescent material light (201); (C) the movable optical element (410) is configured to transmit at least part of the device light (101) received by the movable optical element (410), wherein the movable optical element (410) has an axis of rotation (R), wherein the movable optical element (410) comprises a first face (411) and a second face (412) defining a thickness (d1) of the movable optical element (410), wherein the thickness (d1) varies over the movable optical element (410), wherein at least one of the first face (411) and the second face (412) has an angle (01) relative to a plane (p) defined perpendicular to the axis of rotation (R), wherein 1°≤θ1≤44°; (D) the actuator (420) is configured to move the optical element (410) via rotation about the axis of rotation (R), whereby one or more of a device light spot size of the device light (101) and a device light spot position of the device light (101) on the luminescent material (200) is controlled; (E) the control system (300) is configured to control the actuator (420); and (F) the light generating system (1000) is configured to generate system light (1001) comprising one or more of the device light (101) and the luminescent material light (201).

### FIELD OF THE INVENTION

The invention relates to a light generating system. The invention further relates to a lighting device comprising such light generating system.

### BACKGROUND OF THE INVENTION

Laser-phosphor based stage lighting engines are known in the art. For instance, WO2022143318 describes a light emitting device, comprising a first light source, a second light source, a dichroic mirror, a wavelength conversion apparatus, a first light path adjusting apparatus or a second light path adjusting apparatus, and a first scattering optical system. The light mixing effect of emergent light can be improved by using the first scattering optical system. Light emitted by the first light source is all used for exciting the wavelength conversion apparatus.

US2022/390089A1 discloses a laser-excited-phosphor light-source system in which a phosphor plate remains stationary while a laser beam is made to scan across the phosphor plate. The phosphor-plate assembly includes a plurality of areas each having a different phosphor substance that emits wavelength-converted light in response to excitation from the scanned laser beam and/or a diffusive material. One or more rotating prisms and/or one or more rotating or oscillating or angularly displaced mirrors are used to deflect the input laser light on the way toward the phosphor plate and to deflect the wavelength-converted and/or diffused light in the opposite direction such that the output beam of wavelength-converted and/or diffused light remains stationary with respect to the phosphor plate as the input laser beam is moved across the surface of the phosphor-plate assembly.

WO2020/135304A discloses a light source system and a projection apparatus. The light source system comprises a first light source, a wavelength conversion apparatus, a light concentrating apparatus with a light concentrating lens, with the light concentrating lens being used for concentrating excitation light emitted from the first light source onto the wavelength conversion apparatus, and a light deflection apparatus, arranged in a light path between the first light source and the wavelength conversion apparatus in a time division manner and used for deflecting some of the light beams emitted from the first light source for adjusting the area of light spots that are irradiated by the first light source onto the wavelength conversion apparatus.

US2018/073703 discloses a light module for providing light that includes a plurality of excitation radiation sources designed to emit an excitation radiation beam, at least one phosphor designed to convert the excitation radiation impinging on it into conversion light. A phosphor device, which includes the phosphor, is designed to re-emit excitation radiation beams impinging on it and as conversion light beams or unconverted excitation radiation beams. A deflection device having at least one deflection optical unit is designed to direct at least some of the excitation radiation beams coming from the respective excitation radiation sources onto different regions of the surface of the phosphor device, and an output, at which at least one of the conversion light beams coming from the different regions of the phosphor device or the unconverted excitation radiation beams is provided.

### SUMMARY OF THE INVENTION

High brightness light sources can be used in various applications including spots, stage-lighting, headlamps, home and office lighting, and automotive lighting. For this purpose, laser-phosphor technology can be used, wherein a laser provides laser light and a remote phosphor converts laser light into converted light. A relatively straightforward way to produce white light using lasers is to use laser light in combination with a luminescent converter to generate phosphor converted light. Laser-phosphor systems may allow generation of high brightness light and may therefore be used in projection systems, including displays such as cinema projectors and projectors for home, school, and office applications, car front lighting, search lighting, stage lighting, architectural lighting, and special lighting applications. However, such light engine may be capable to generate only a single color point as defined by the luminescent converter. Creation of a product range providing different color points may be difficult as it may require multiple unique components to be designed, qualified, produced, and kept in stock. In other cases, e.g. in RGB LCD-based projection systems, the maximum brightness may be limited by the components used, the engine volume may be large due to the many components, and the system cost may be high due to the many dedicated components. A way to combine pump light and luminescent light may be to use a polarizing beam splitter for the pump light, by which part of the light is reflected to the luminescent material and part is transmitted to a diffuser. However, in general the diffused light may to a large degree be depolarized, which may result in relatively high losses of diffused blue light at the beam combiner where it is combined with the luminescent light into white output light.

Hence, it is an aspect of the invention to provide an alternative light generating system, which preferably further at least partly obviates one or more of above-described drawbacks. The present invention may have as an objective to overcome or ameliorate at least one of the disadvantages of the prior art, or to provide a useful alternative.

According to a first aspect, the invention provides a light generating system (“system”) comprising (i) one or more light generating devices, (ii) a luminescent material arrangement, (iii) a movable optical element, (iv) an actuator, and (v) a control system. The one or more light generating devices may, in embodiments, be configured to generate device light. Therefore, in embodiments, the one or more light generating devices may comprise a solid state light source. Especially, in embodiments, the one or more light generating devices may comprise one or more solid state light sources, such as one or more of a light emitting diode (LED), a laser diode, and a superluminescent diode. Further, the luminescent material arrangement may, in embodiments, comprise a luminescent material. Especially, in embodiments, the luminescent material may be configured to receive at least part of the device light. More especially, in embodiments, the luminescent material arrangement may comprise a luminescent material configured to convert at least part of the device light received by the luminescent material into luminescent material light. Further, in embodiments, the movable optical element may be configured to receive at least part of the device light. Especially, in embodiments, the movable optical element may be configured to transmit at least part of the device light received by the movable optical element. Additionally or alternatively, in embodiments, the movable optical element may be configured to transmit at least part of the device light and the luminescent material light received by the movable optical element. The movable optical element may, in embodiments, have an axis of rotation (R). In embodiments, a plane (p) may be defined perpendicular to the axis of rotation (R). Further, in embodiments, the movable optical element may comprise a first face and a second face. In embodiments, at least one of the first face and the second face may have an angle (θ1) relative to the plane (p) (defined perpendicular to the axis of rotation (R). Especially, in embodiments, 1°≤θ1≤44°, such as 5°≤θ1<40°. Further, in embodiments, the actuator may be configured to move the optical element via one or more of translation and rotation, especially via translation, or especially via rotation (about the axis of rotation(R)), or especially via both translation and rotation (about the axis of rotation(R)). In such embodiments, by moving the optical element one or more of a device light spot size of the device light and a device light spot position of the device light on the luminescent material may be controlled. The control system may therefore, in embodiments, be configured to control the actuator. In embodiments, the light generating system may be configured to generate system light. Especially, in embodiments, the system light may comprise one or more of device light and luminescent material light. Hence, in specific embodiments the invention provides a light generating system comprising (i) one or more light generating devices, (ii) a luminescent material arrangement, (iii) a movable optical element, (iv) an actuator, and (v) a control system, wherein: (A) the one or more light generating devices may be configured to generate device light; wherein the one or more light generating devices may comprise one or more of a laser diode and a superluminescent diode; (B) the luminescent material arrangement may comprise a luminescent material configured to convert at least part of the device light received by the luminescent material into luminescent material light; (C) the movable optical element may be configured to transmit at least part of the device light received by the movable optical element, wherein the movable optical element may have an axis of rotation (R), wherein the movable optical element may comprise a first face and a second face, wherein at least one of the first face and the second face may have an angle (θ1) relative to a plane (p) defined perpendicular to the axis of rotation (R), wherein 1°≤θ1≤44°; (D) the actuator may be configured to move the optical element via rotation about the axis of rotation (R), whereby one or more of a device light spot size of the device light and a device light spot position of the device light on the luminescent material may be controlled; (E) the control system may be configured to control the actuator; and (F) the light generating system may be configured to generate system light comprising one or more of the device light and the luminescent material light.

With such system, a high power light generating system may be provided. Further, such system may allow control of spectral power distribution of the system light (of a high power system). Yet, such system may in a safe way provide high power light. The system may be relatively compact. Yet, thermal management of the luminescent material may also be provided with this system. In addition to high optical power, the system may also provide high radiance (or luminance), i.e., a high optical power density of the source. Embodiments of the system may be more fail-safe thanks to the reflective configuration for both the luminescent light and diffused light, by which it can be prevented that direct laser beams emit from the system in case the luminescent component or a diffusing component would fail (e.g. break, fall off, etc.). Of course the system may also function as a static system, but in embodiments a rotating optical wedge may be used here due to its reducing effect on the local (and temporal) peak temperature in the luminescent material, i.e., leading to good heat spreading and cooling properties. Overall, a typical advantage may be that in embodiments from two (different) laser sources only part of one source may be used for diffusion and more than one source for luminescent conversion. Thereby, such embodiments may enable the most efficient use of a combination of two laser sources while also enabling maximum output light using two laser sources, e.g. when using two sources with comparable dimensions (e.g. the same number of laser diodes in convenient configurations). Therefore, amongst others in embodiments a tunable laser phosphor engine with rotating optical wedge (though other shapes are also possible, see also below) is provided, wherein the tunable laser phosphor engine may comprise (i) a movable optical element and (ii) an actuator configured to move the optical element via one or more of translation and rotation.

As indicated above, the light generating system may in embodiments comprise one or more light generating devices, a luminescent material arrangement, a movable optical element, an actuator, and a control system.

In embodiments, the light generating system may comprise one or more light generating devices, such as one light generating device, like two light generating devices. A light generating device may especially be configured to generate device light. Especially, the light generating device may comprise a light source. The light source may especially be configured to generate light source light. In embodiments, the device light may essentially consist of the light source light. In other embodiments, the device light may essentially consist of converted light source light. In yet other embodiments, the device light may comprise (unconverted) light source light and converted light source light. Light source light may be converted with a luminescent material into luminescent material light and/or with an upconverter into upconverted light (see also below). The term “light generating device” may also refer to a plurality of light generating devices which may provide device light having essentially the same spectral power distributions. In (other) specific embodiments, the term “light generating device” may also refer to a plurality of light generating devices which may provide device light having different spectral power distributions.

The term “light source” may in principle relate to any light source known in the art. It may be a conventional (tungsten) light bulb, a low pressure mercury lamp, a high pressure mercury lamp, a fluorescent lamp, an LED (light emissive diode). In a specific embodiment, the light source comprises a solid state LED light source (such as an LED or laser diode (or “diode laser”)). The term “light source” may also relate to a plurality of light sources, such as 2-2000 (solid state) LED light sources. Hence, the term LED may also refer to a plurality of LEDs. Further, the term “light source” may in embodiments also refer to a so-called chip-on-board (COB) light source. The term “COB” especially refers to LED chips in the form of a semiconductor chip that is neither encased nor connected but directly mounted onto a substrate, such as a PCB. Hence, a plurality of light emitting semiconductor light source may be configured on the same substrate. In embodiments, a COB is a multi LED chip configured together as a single lighting module.

The light source may have a light escape surface. Referring to conventional light sources such as light bulbs or fluorescent lamps, it may be an outer surface of a glass or a quartz envelope. For LED's it may for instance be the LED die, or when a resin is applied to the LED die, the outer surface of the resin. In principle, it may also be the terminal end of a fiber. The term escape surface especially relates to that part of the light source, where the light actually leaves or escapes from the light source. The light source is configured to provide a beam of light. This beam of light (thus) escapes from the light exit surface of the light source. Likewise, a light generating device may comprise a light escape surface, such as an end window. Further, likewise a light generating system may comprise a light escape surface, such as an end window. A position where system light escapes from the light generating system may also be indicated as light exit. This may be a light transmissive window or an opening (in the system). The light transmissive window may in embodiments be provided by an optical component.

The term “light source” may refer to a semiconductor light-emitting device, such as a light emitting diode (LEDs), a laser diode, a resonant cavity light emitting diode (RCLED), a vertical cavity laser diode (VCSELs), an edge emitting laser (EEL), a photonic crystal surface emitting laser (PCSEL), a vertical external cavity surface emitting laser (VECSEL), etc . . . The term “light source” may also refer to an organic light-emitting diode (OLED), such as a passive-matrix (PMOLED) or an active-matrix (AMOLED). In a specific embodiment, the light source comprises a solid-state light source (such as an LED or laser diode). In an embodiment, the light source comprises an LED (light emitting diode). The terms “light source” or “solid state light source” may also refer to a superluminescent diode (SLED).

The term LED may also refer to a plurality of LEDs.

The light source may especially be configured to generate light source light having an optical axis (O), (a beam shape,) and a spectral power distribution. The light source light may in embodiments comprise one or more bands, having band widths as known for lasers.

The term “light source” may (thus) refer to a light generating element as such, like e.g. a solid state light source, or e.g. to a package of the light generating element, such as a solid state light source, and one or more of a luminescent material comprising element and (other) optics, like a lens, a collimator. A light converter element (“converter element” or “converter”) may comprise a luminescent material comprising element. For instance, a solid state light source as such, like a blue LED, is a light source. A combination of a solid state light source (as light generating element) and a light converter element, such as a blue LED and a light converter element, optically coupled to the solid state light source, may also be a light source (but may also be indicated as light generating device). Hence, a white LED is a light source (but may e.g. also be indicated as (white) light generating device).

In embodiments, the term “light source” may also refer to a combination of a light source, like an LED, and an optical filter, which may change the spectral power distribution of the light generated by the light source. Especially, the term “light generating device” may be used to address a light source and further (optical components), like an optical filter and/or a beam shaping element, etc.

The phrases “different light sources” or “a plurality of different light sources”, and similar phrases, may in embodiments refer to a plurality of solid-state light sources selected from at least two different bins. Likewise, the phrases “identical light sources” or “a plurality of same light sources”, and similar phrases, may in embodiments refer to a plurality of solid-state light sources selected from the same bin.

The term “solid state light source”, or “solid state material light source”, and similar terms, may especially refer to semiconductor light sources, such as a light emitting diode (LED), a laser diode, or a superluminescent diode.

The term “laser light source” especially refers to a laser. Such laser may especially be configured to generate laser light source light having one or more wavelengths in the UV, visible, or infrared, especially having a wavelength selected from the spectral wavelength range of 200-2000 nm, such as 300-1500 nm. The term “laser” especially refers to a device that emits light through a process of optical amplification based on the stimulated emission of electromagnetic radiation.

Especially, in embodiments the term “laser” may refer to a solid-state laser. In specific embodiments, the terms “laser” or “laser light source”, or similar terms, refer to a laser diode (or diode laser). Hence, in embodiments the light source comprises a laser light source. In embodiments, the terms “laser” or “solid state laser” or “solid state material laser” may refer to one or more of cerium doped lithium strontium (or calcium) aluminum fluoride (Ce:LiSAF, Ce:LiCAF), chromium doped chrysoberyl (alexandrite) laser, chromium ZnSe (Cr:ZnSe) laser, divalent samarium doped calcium fluoride (Sm:CaF₂) laser, Er: YAG laser, erbium doped and erbium-ytterbium codoped glass lasers, F-Center laser, holmium YAG (Ho:YAG) laser, Nd:YAG laser, NdCrYAG laser, neodymium doped yttrium calcium oxoborate Nd:YCa₄O(BO₃)₃ or Nd:YCOB, neodymium doped yttrium orthovanadate (Nd:YVO₄) laser, neodymium glass (Nd:glass) laser, neodymium YLF (Nd:YLF) solid-state laser, promethium 147 doped phosphate glass (147Pm³⁺:glass) solid-state laser, ruby laser (Al₂O₃:Cr³⁺), thulium YAG (Tm:YAG) laser, titanium sapphire (Ti:sapphire; Al₂O₃:Ti³⁺) laser, trivalent uranium doped calcium fluoride (U:CaF₂) solid-state laser, Ytterbium doped glass laser (rod, plate/chip, and fiber), Ytterbium YAG (Yb:YAG) laser, Yb₂O₃ (glass or ceramics) laser, etc. For instance, including second and third harmonic generation embodiments, the light source may comprise one or more of an F center laser, an yttrium orthovanadate (Nd:YVO₄) laser, a promethium 147 doped phosphate glass (147Pm³⁺:glass), and a titanium sapphire (Ti:sapphire; Al₂O₃:Ti³⁺) laser. For instance, considering second and third harmonic generation, such light sources may be used to generated blue light. In embodiments, the terms “laser” or “solid state laser” or “solid state material laser” may refer to one or more of a semiconductor laser diodes, such as GaN, InGaN, AlGaInP, AlGaAs, InGaAsP, lead salt, vertical cavity surface emitting laser (VCSEL), quantum cascade laser, hybrid silicon laser, etc. A laser may be combined with an upconverter in order to arrive at shorter (laser) wavelengths. For instance, with some (trivalent) rare earth ions upconversion may be obtained or with non-linear crystals upconversion can be obtained. Alternatively, a laser can be combined with a downconverter, such as a dye laser, to arrive at longer (laser) wavelengths.

As can be derived from the below, the term “laser light source” may also refer to a plurality of (different or identical) laser light sources. In specific embodiments, the term “laser light source” may refer to a plurality N of (identical) laser light sources. In embodiments, N=2, or more. In specific embodiments, N may be at least 5, such as especially at least 8. In this way, a higher brightness may be obtained. In embodiments, laser light sources may be arranged in a laser bank (see also above). The laser bank may in embodiments comprise heat sinking and/or optics e.g. a lens to collimate the laser light. Hence, in embodiments lasers in a laser bank (or “laser array bank”) may share the same optics.

The laser light source is configured to generate laser light source light (or “laser light”). The light source light may essentially consist of the laser light source light. The light source light may also comprise laser light source light of two or more (different or identical) laser light sources. For instance, the laser light source light of two or more (different or identical) laser light sources may be coupled into a light guide, to provide a single beam of light comprising the laser light source light of the two or more (different or identical) laser light sources. In specific embodiments, the light source light is thus especially collimated light source light. In yet further embodiments, the light source light is especially (collimated) laser light source light.

The laser light source light may in embodiments comprise one or more bands, having band widths as known for lasers. In specific embodiments, the band(s) may be relatively sharp line(s), such as having full width half maximum (FWHM) in the range of less than 20 nm at RT, such as equal to or less than 10 nm. Hence, the light source light has a spectral power distribution (intensity on an energy scale as function of the wavelength) which may comprise one or more (narrow) bands.

The beams (of light source light) may be focused or collimated beams of (laser) light source light. The term “focused” may especially refer to converging to a small spot. This small spot may be at the discrete converter region, or (slightly) upstream thereof or (slightly) downstream thereof. Especially, focusing and/or collimation may be such that the cross-sectional shape (perpendicular to the optical axis) of the beam at the discrete converter region (at the side face) is essentially not larger than the cross-section shape (perpendicular to the optical axis) of the discrete converter region (where the light source light irradiates the discrete converter region). Focusing may be executed with one or more optics, like (focusing) lenses. Especially, two lenses may be applied to focus the laser light source light. Collimation may be executed with one or more (other) optics, like collimation elements, such as lenses and/or parabolic mirrors. In embodiments, the beam of (laser) light source light may be relatively highly collimated, such as in embodiments ≤2° (FWHM), more especially ≤1° (FWHM), most especially ≤0.5° (FWHM). Hence, ≤2° (FWHM) may be considered (highly) collimated light source light. Optics may be used to provide (high) collimation (see also above).

The term “solid state material laser”, and similar terms, may refer to a solid state laser like based on a crystalline or glass body dopes with ions, like transition metal ions and/or lanthanide ions, to a fiber laser, to a photonic crystal laser, to a semiconductor laser, such as e.g. a vertical cavity surface-emitting laser (VCSEL), etc.

Instead of the term “solid state light source” also the term “semiconductor-based light source” may be applied. Hence, the term “semiconductor-based light source” may e.g. refer to one or more of a light emitting diode (LED), a laser diode, and a superluminescent diode. Hence, the light generating device may comprise one or more of a light emitting diode (LED), a laser diode, and a superluminescent diode.

A laser diode (or diode laser) may be a semiconductor device substantially similar to a light-emitting diode in which a diode pumped directly with electrical current can create lasing conditions at the diode's junction. This is known to a person skilled in the art.

Superluminescent diodes are known in the art. A superluminescent diode may be indicated as a semiconductor device which may be able to emit low-coherence light of a broad spectrum like an LED, while having a brightness in the order of a laser diode. US2020192017 indicates for instance that “With current technology, a single SLED is capable of emitting over a bandwidth of, for example, at most 50-70 nm in the 800-900 nm wavelength range with sufficient spectral flatness and sufficient output power. In the visible range used for display applications, i.e. in the 450-650 nm wavelength range, a single SLED is capable of emitting over bandwidth of at most 10-30 nm with current technology. Those emission bandwidths are too small for a display or projector application which requires red (640 nm), green (520 nm) and blue (450 nm), i.e. RGB, emission”. Further, superluminescent diodes are amongst others described, in “Edge Emitting Laser Diodes and Superluminescent Diodes”, Szymon Stanczyk, Anna Kafar, Dario Schiavon, Stephen Najda, Thomas Slight, Piotr Perlin, Book Editor(s): Fabrizio Roccaforte, Mike Leszczynski, First published: 3 Aug. 2020 https://doi.org/10.1002/9783527825264.ch9 in chapter 9.3 superluminescent diodes. This book, and especially chapter 9.3, are herein incorporated by reference. Amongst others, it is indicated therein that the superluminescent diode (SLD) is an emitter, which combines the features of laser diodes and light-emitting diodes. SLD emitters utilize the stimulated emission, which means that these devices operate at current densities similar to those of laser diodes. The main difference between LDs and SLDs is that in the latter case, the device waveguide may be designed in a special way preventing the formation of a standing wave and lasing. Still, the presence of the waveguide ensures the emission of a high-quality light beam with high spatial coherence of the light, but the light is characterized by low time coherence at the same time” and “Currently, the most successful designs of nitride SLD are bent, curved, or tilted waveguide geometries as well as tilted facet geometries, whereas in all cases, the front end of the waveguide meets the device facet in an inclined way, as shown in FIG. 9.10. The inclined waveguide suppresses the reflection of light from the facet to the waveguide by directing it outside to the lossy unpumped area of the device chip”. Hence, an SLD may especially be a semiconductor light source, where the spontaneous emission light is amplified by stimulated emission in the active region of the device. Such emission is called “super luminescence”. Superluminescent diodes combine the high power and brightness of laser diodes with the low coherence of conventional light-emitting diodes. The low (temporal) coherence of the source has advantages that the speckle is significantly reduced or not visible, and the spectral distribution of emission is much broader compared to laser diodes, which can be better suited for lighting applications. Especially, with varying electrical current, the spectral power distribution of the superluminescent diode may vary. In this way the spectral power distribution can be controlled, see e.g. also Abdullah A. Alatawi, et al., Optics Express Vol. 26, Issue 20, pp. 26355-26364, https://doi.org/10.1364/OE.26.026355. Hence, a superluminescent diode may be indicated as a semiconductor device which may be able to emit low-coherence light of a broad spectrum like a LED, while having a brightness in the order of a laser diode. Superluminescent diodes may combine the high power and brightness of laser diodes with the low coherence of conventional light-emitting diodes. The low (temporal) coherence of the source has advantages that the speckle is significantly reduced or not visible, and the spectral distribution of emission is much broader compared to laser diodes, which can be better suited for lighting applications. Hence, in embodiments, the solid state light source may comprise a superluminescent diode. For instance, in further specific embodiments, the solid state light source may comprise a GaN-based superluminescent diode, or an InGaN-based superluminescent diode, or an AlGaN-based superluminescent diode.

In specific embodiments, the device light may be blue light. The terms “blue light” or “blue emission”, and similar terms, may especially relate to light having a wavelength in the range of about 430-490 nm (including some violet and cyan hues). In specific embodiments, the blue light may have a centroid wavelength in the 430-490 nm range, such as in the 440-490 nm range. In specific embodiments, the peak wavelength of the device light is selected from the blue wavelength range. In embodiments, the one or more light generating devices comprise a light source selected from a laser diode and a superluminescent diode. Hence, especially the one or more light generating devices may comprise a solid state light source. More especially, the device light may be laser light.

Further, the light generating system may comprise a luminescent material arrangement. In embodiments, the luminescent material arrangement comprises a luminescent material. The term “luminescent material” especially refers to a material that can convert first radiation, especially one or more of UV radiation and blue radiation, into second radiation. In general, the first radiation and second radiation have different spectral power distributions. Hence, instead of the term “luminescent material”, also the terms “luminescent converter” or “converter” may be applied. In general, the second radiation has a spectral power distribution at larger wavelengths than the first radiation, which is the case in the so-called down-conversion. In specific embodiments, however the second radiation has a spectral power distribution with intensity at smaller wavelengths than the first radiation, which is the case in the so-called up-conversion. In embodiments, the “luminescent material” may especially refer to a material that can convert radiation into e.g. visible and/or infrared light. For instance, in embodiments the luminescent material may be able to convert one or more of UV radiation and blue radiation, into visible light. The luminescent material may in specific embodiments also convert radiation into infrared radiation (IR). Hence, upon excitation with radiation, the luminescent material emits radiation. In general, the luminescent material will be a down converter, i.e. radiation of a smaller wavelength is converted into radiation with a larger wavelength (λₑₓ<λₑₘ), though in specific embodiments the luminescent material may comprise up-converter luminescent material, i.e. radiation of a larger wavelength is converted into radiation with a smaller wavelength (λₑₓ>λₑₘ). In embodiments, the term “luminescence” may refer to phosphorescence. In embodiments, the term “luminescence” may also refer to fluorescence. Instead of the term “luminescence”, also the term “emission” may be applied. Hence, the terms “first radiation” and “second radiation” may refer to excitation radiation and emission (radiation), respectively. Likewise, the term “luminescent material” may in embodiments refer to phosphorescence and/or fluorescence. The term “luminescent material” may also refer to a plurality of different luminescent materials. Examples of possible luminescent materials are indicated below. Hence, the term “luminescent material” may in specific embodiments also refer to a luminescent material composition. Instead of the term “luminescent material” also the term “phosphor” may be applied. These terms are known to the person skilled in the art.

In embodiments, luminescent materials are selected from garnets and nitrides, especially doped with trivalent cerium or divalent europium, respectively. The term “nitride” may also refer to oxynitride or nitridosilicate, etc. Alternatively or additionally, the luminescent material(s) may be selected from silicates, especially doped with divalent europium.

In specific embodiments the luminescent material comprises a luminescent material of the type A₃B₅O₁₂:Ce, wherein A in embodiments comprises one or more of Y, La, Gd, Tb and Lu, especially (at least) one or more of Y, Gd, Tb and Lu, and wherein B in embodiments comprises one or more of Al, Ga, In and Sc. Especially, A may comprise one or more of Y, Gd and Lu, such as especially one or more of Y and Lu. Especially, B may comprise one or more of Al and Ga, more especially at least Al, such as essentially entirely Al. Hence, especially suitable luminescent materials are cerium comprising garnet materials. Embodiments of garnets especially include A₃B₅O₁₂ garnets, wherein A comprises at least yttrium or lutetium and wherein B comprises at least aluminum. Such garnets may be doped with cerium (Ce), with praseodymium (Pr) or a combination of cerium and praseodymium; especially however with Ce. Especially, B may comprise aluminum (Al); however, in addition to aluminum, B may also partly comprise gallium (Ga) and/or scandium (Sc) and/or indium (In), especially up to about 20% of B, more especially up to about 10 % of B (i.e. the B ions essentially consist of 90 or more mole % of Al and 10 or less mole % of one or more of Ga, Sc and In); B may especially comprise up to about 10% gallium. In another variant, B and O may at least partly be replaced by Si and N. The element A may especially be selected from the group consisting of yttrium (Y), gadolinium (Gd), terbium (Tb) and lutetium (Lu). Further, Gd and/or Tb are especially only present up to an amount of about 20% of A. In a specific embodiment, the garnet luminescent material comprises (Y₁₋ₓLuₓ)₃B₅O₁₂:Ce, wherein x is equal to or larger than 0 and equal to or smaller than 1. The term “:Ce”, indicates that part of the metal ions (i.e. in the garnets: part of the “A” ions) in the luminescent material is replaced by Ce. For instance, in the case of (Y₁₋ₓLuₓ)₃Al₅O₁₂:Ce, part of Y and/or Lu is replaced by Ce. This is known to the person skilled in the art. Ce will replace A in general for not more than 10%; in general, the Ce concentration will be in the range of 0.1 to 4%, especially 0.1 to 2% (relative to A). Assuming 1% Ce and 10% Y, the full correct formula could be (Y_{0.1}Lu_{0.89}Ce_{0.01})₃Al₅O₁₂. Ce in garnets is substantially or only in the trivalent state, as is known to the person skilled in the art.

In embodiments, the luminescent material (thus) comprises A₃B₅O₁₂ wherein in specific embodiments at maximum 10% of B—O may be replaced by Si—N. Here, B in B—O refers to one or more of Al, Ga, In and Sc (and O refers to oxygen); in specific embodiments B—O may refer to Al—O. As indicated above, in specific embodiments x3 may be selected from the range of 0.001-0.04. Especially, such luminescent materials may have a suitable spectral distribution (see however below), have a relatively high efficiency, have a relatively high thermal stability, and allow a high CRI (optionally in combination with (the) light of other sources of light as described herein). Hence, in specific embodiments A may be selected from the group consisting of Lu and Gd. Alternatively or additionally, B may comprise Ga. Hence, in embodiments the luminescent material comprises (Yₓ₁(Lu,Gd)ₓ₂Ceₓ₃)₃(Al_{y1}Ga_{y2})₅O₁₂, wherein Lu and/or Gd may be available. Even more especially, x3 is selected from the range of 0.001-0.1, wherein 0<x2+x3≤0.1, and wherein 0≤y2≤0.1. Further, in specific embodiments, at maximum 1% of B—O may be replaced by Si—N. Here, the percentage refers to moles (as known in the art); see e.g. also EP3149108. In yet further specific embodiments, the luminescent material comprises (Yₓ₁Ceₓ₃)₃Al₅O₁₂, wherein x1+x3=1, and wherein 0<x3≤0.2, such as 0.001-0.1.

In specific embodiments, the light generating device may only include luminescent materials selected from the type of cerium comprising garnets. In even further specific embodiments, the light generating device includes a single type of luminescent materials, such as (Yₓ₁A′ₓ₂Ceₓ₃)₃(Al_{y1}B′_{y2})₅O₁₂. Hence, in specific embodiments the light generating device comprises luminescent material, wherein at least 85 weight %, even more especially at least about 90 wt. %, such as yet even more especially at least about 95 weight % of the luminescent material comprises (Yₓ₁A′ₓ₂Ceₓ₃)₃(Al_{y1}B′_{y2})₅O₁₂. Here, wherein A′ comprises one or more elements selected from the group consisting of lanthanides, and wherein B′ comprises one or more elements selected from the group consisting of Ga, In and Sc, wherein x1+x2+x3=1, wherein x3>0, wherein 0<x2+x3≤0.2, wherein y1+y2=1, wherein 0≤y2≤0.2. Especially, x3 is selected from the range of 0.001-0.1. Note that in embodiments x2=0. Alternatively or additionally, in embodiments y2=0.

In specific embodiments, A may especially comprise at least Y, and B may especially comprise at least Al.

Alternatively or additionally, the luminescent material may comprise a luminescent material of the type A₃Si₆N₁₁:Ce³⁺, wherein A comprises one or more of Y, La, Gd, Tb and Lu, such as in embodiments one or more of La and Y. In embodiments, the luminescent material may alternatively or additionally comprise one or more of MS:Eu²⁺ and/or M₂Si₅N₈:Eu²⁺ and/or MAlSiN₃:Eu²⁺ and/or Ca₂AlSi₃O₂N₅:Eu²⁺, etc., wherein M comprises one or more of Ba, Sr and Ca, especially in embodiments at least Sr. Hence, in embodiments, the luminescent may comprise one or more materials selected from the group consisting of (Ba,Sr,Ca)S:Eu, (Ba,Sr,Ca)AlSiN₃:Eu and (Ba,Sr,Ca)₂Si₅N₈:Eu. In these compounds, europium (Eu) is substantially or only divalent, and replaces one or more of the indicated divalent cations. In general, Eu will not be present in amounts larger than 10% of the cation; its presence will especially be in the range of about 0.5 to 10%, more especially in the range of about 0.5 to 5% relative to the cation(s) it replaces. The term “:Eu”, indicates that part of the metal ions is replaced by Eu (in these examples by Eu²⁺). For instance, assuming 2% Eu in CaAlSiN₃:Eu, the correct formula could be (Ca_{0.98}Eu_{0.02})AlSiN₃. Divalent europium will in general replace divalent cations, such as the above divalent alkaline earth cations, especially Ca, Sr or Ba. The material (Ba,Sr,Ca)S:Eu can also be indicated as MS:Eu, wherein M is one or more elements selected from the group consisting of barium (Ba), strontium (Sr) and calcium (Ca); especially, M comprises in this compound calcium or strontium, or calcium and strontium, more especially calcium. Here, Eu is introduced and replaces at least part of M (i.e. one or more of Ba, Sr, and Ca). Further, the material (Ba,Sr,Ca)₂Si₅N₈:Eu can also be indicated as M₂Si₅N₈:Eu, wherein M is one or more elements selected from the group consisting of barium (Ba), strontium (Sr) and calcium (Ca); especially, M comprises in this compound Sr and/or Ba. In a further specific embodiment, M consists of Sr and/or Ba (not taking into account the presence of Eu), especially 50 to 100%, more especially 50 to 90% Ba and 50 to 0%, especially 50 to 10% Sr, such as Ba_{1.5}Sr_{0.5}Si₅N₈:Eu (i.e. 75% Ba; 25% Sr). Here, Eu is introduced and replaces at least part of M, i.e. one or more of Ba, Sr, and Ca). Likewise, the material (Ba,Sr,Ca)AlSiN₃:Eu can also be indicated as MAlSiN₃:Eu, wherein M is one or more elements selected from the group consisting of barium (Ba), strontium (Sr) and calcium (Ca); especially, M comprises in this compound calcium or strontium, or calcium and strontium, more especially calcium. Here, Eu is introduced and replaces at least part of M (i.e. one or more of Ba, Sr, and Ca). Eu in the above indicated luminescent materials is substantially or only in the divalent state, as is known to the person skilled in the art.

The term “luminescent material” herein especially relates to inorganic luminescent materials.

Alternatively or additionally, also other luminescent materials may be applied. For instance quantum dots and/or organic dyes may be applied and may optionally be embedded in transmissive matrices like e.g. polymers, like PMMA, or polysiloxanes, etc. etc.. Quantum dots are small crystals of semiconducting material generally having a width or diameter of only a few nanometers. When excited by incident light, a quantum dot emits light of a color determined by the size and material of the crystal. Light of a particular color can therefore be produced by adapting the size of the dots. Most known quantum dots with emission in the visible range are based on cadmium selenide (CdSe) with a shell such as cadmium sulfide (CdS) and zinc sulfide (ZnS). Cadmium free quantum dots such as indium phosphide (InP), and copper indium sulfide (CuInS₂) and/or silver indium sulfide (AgInS₂) can also be used. Quantum dots show very narrow emission band and thus they show saturated colors. Furthermore the emission color can easily be tuned by adapting the size of the quantum dots. Any type of quantum dot known in the art may be used in the present invention. However, it may be preferred for reasons of environmental safety and concern to use cadmium-free quantum dots or at least quantum dots having a very low cadmium content.

Instead of quantum dots or in addition to quantum dots, also other quantum confinement structures may be used. The term “quantum confinement structures” should, in the context of the present application, be understood as e.g. quantum wells, quantum dots, quantum rods, tripods, tetrapods, or nanowires, etcetera. Organic phosphors can be used as well. Examples of suitable organic phosphor materials are organic luminescent materials based on perylene derivatives, for example compounds sold under the name Lumogen® by BASF. Examples of suitable compounds include, but are not limited to, Lumogen® Red F305, Lumogen® Orange F240, Lumogen® Yellow F083, and Lumogen® F170.

Different luminescent materials may have different spectral power distributions of the respective luminescent material light. Alternatively or additionally, such different luminescent materials may especially have different color points (or dominant wavelengths).

As indicated above, other luminescent materials may also be possible. Hence, in specific embodiments the luminescent material is selected from the group of divalent europium containing nitrides, divalent europium containing oxynitrides, divalent europium containing silicates, cerium comprising garnets, and quantum structures. Quantum structures may e.g. comprise quantum dots or quantum rods (or other quantum type particles) (see above). Quantum structures may also comprise quantum wells. Quantum structures may also comprise photonic crystals. In embodiments, the luminescent material may at least comprise a luminescent material of the type A₃B₅O₁₂:Ce, wherein A comprises one or more of Y, La, Gd, Tb and Lu, and wherein B comprises one or more of Al, Ga, In and Sc.

Especially, the luminescent material may be configured to convert device light received by the luminescent material into luminescent material light. Hence, the luminescent material may be configured in the system such that, together with optics, device light may reach the luminescent material. More especially, at least part of the device light reaches the luminescent material, such as at least 50% of the device light, like at least 60% of the device light, especially at least 70% of the device light. Especially, the luminescent material may be configured in the system such that, together with optics, at least part of the device light may irradiate the luminescent material. Whether all of the device light irradiates the luminescent material may in embodiments depend e.g. on its polarization (see also below). Hence, the luminescent material, and the one or more light generating devices are selected such that the luminescent material is in principle able to convert at least part of the device light. In embodiments, the luminescent material may have an excitation band, especially in the blue wavelength range, having an excitation wavelength range defined by the full width half maximum of the excitation band, wherein the first wavelength λ1 (and optionally the second wavelength λ2) is within the excitation wavelength. Therefore, in embodiments the luminescent material may be configured to convert device light received by the luminescent material into luminescent material light. More especially, in embodiments during operation the luminescent material may convert device light received by the luminescent material into luminescent material light.

A luminescent material arrangement may be configured in a reflective mode or in a transmissive mode. Herein, when an element is indicated to be operated in a transmissive mode this may, in embodiments, imply that at one or more wavelengths the part of the radiation that is transmitted may be larger than the part of the radiation that is reflected or absorbed. Herein, when an element is indicated to be operated in a reflective mode this may in embodiments imply that at one or more wavelengths the part of the radiation that is reflected may be larger than the part of the radiation that is transmitted or absorbed. Hence, the luminescent material arrangement may be transparent or light scattering.

Hence, the luminescent material may be configured in the reflective mode or in the transmissive mode. In the transmissive mode, it may be relatively easy to have light source light admixed in the luminescent material light, which may be useful for generating the desirable spectral power distribution. In the reflective mode, thermal management may be more easy, as a substantial part of the luminescent material may be in thermal contact with a thermally conductive element, like a heatsink or heat spreader. With high power irradiation of the luminescent material, the thermal load may become critical. Hence, in embodiments the luminescent material may be configured to extend in a circular configuration, such as on a disc, and irradiation of the luminescent material may be provided locally in a moving fashion during operation of the system. In this way, the luminescent material is only temporarily heated, and is allowed to cool during a (short) time before it is again irradiated. Hence, in embodiments the system may comprise a movable optical element.

In embodiments, the movable optical element may have an axis of rotation (R). The axis of rotation (or rotational axis) may especially be defined as an imaginary line through fixed points of the movable optical element around which all other points of the movable optical element may rotate (during operation of the system). In embodiments, a plane (p) may be defined perpendicular to the axis of rotation (R), i.e., the axis of rotation (R) may be the normal to the plane (p).

Further, in embodiments, the movable optical element may have a first face and a second face. Especially, the movable optical element may be configured downstream of the one or more light generating devices, and upstream of the luminescent material. Hence, in embodiments, the first face may be configured facing the one or more light generating devices, especially, configured in a light receiving relationship with the one or more light generating devices. Conversely, in embodiments, the second face may be configured facing the luminescent material (arrangement), especially, the luminescent material (arrangement) may be configured in a light receiving relationship with the second face (of the movable optical element).

Yet further, in embodiments, at least one of the first face and the second face may have an angle (θ1) relative to the plane (p). In such embodiments, device light incident on the movable optical element may be refracted by the first face and the second face, such that the direction of the device light may be changed. Especially, the refraction may provide a tilted beam of device light, see also further below. Hence, in embodiments, especially the first face may have the angle (θ1) relative to the plane (p). Or especially, in embodiments, the second face may have the angle (θ1) relative to the plane (p). In some embodiments, the first face and the second face may both have a different angle (θ1) relative to the plane (p). Especially, in embodiments, the angle (θ1) may be at least 1°, such as at least 2°, like at least 5°, especially at least 10°. Further, in embodiments, the angle (θ1) may be at most 44°, such as at most 40°, like at most 35°. Hence, in embodiments, 1°≤θ1≤44°, such as 1°≤θ1≤40°, like 2°≤θ1≤35°. Hence, in specific embodiments the first face and the second face may not be mirror images relative to the plane (p).

As mentioned above, in embodiments, the movable optical element may be configured in a light receiving relationship with the one or more light generating devices (optionally via one or more other elements, such as one or more optics, see also further below). Similarly, in embodiments, the luminescent material may be configured in a light receiving relationship with the movable optical element (optionally via one or more other elements, such as one or more optics, see also further below). Therefore, in embodiments, the movable optical element may be configured to transmit at least part of the device light received by the movable optical element. In embodiments, the movable optical element may, especially, be configured to transmit at least part of the device light and the luminescent material light received by the movable optical element. Especially, in embodiments, the movable optical element may be configured to transmit at least 70% of the device light (and luminescent material light) received by the movable optical element, such as at least 80%, like at least 90%, especially at least 95%, including 100%. Hence, in embodiments the luminescent material may be configured in a light receiving relationship with the one or more light generating devices via the movable optical element.

Hence, the light generating system may further comprise an actuator. The actuator may especially be configured to move the movable optical element. Especially, the actuator may be configured to move the movable optical element via one or more of translation and rotation. Hence, in embodiments, the actuator may be configured to control the spatial configuration of the movable optical element through translation. In such embodiments, especially, the translation of the movable optical element may occur in a direction perpendicular to an optical axis of an incident beam. Furthermore, in such embodiments (though not exclusively), the movable optical element may especially comprise a sequence of increases and decreases in thickness (d1) over the movable optical element, see also further below. Additionally or alternatively, the actuator may be configured to rotate the movable optical element, especially to rotate the movable optical element around its axis of rotation (R). By moving the movable optical element, in embodiments, a device light spot size may be controlled. Especially, by moving the movable optical element extra beam divergence or beam convergence may be introduced, which may change the device light spot size. Additionally or alternatively, by moving the movable optical element, in embodiments, a device light spot position of the device light on the luminescent material may be controlled. The device light may, in embodiments, have an optical axis (O). The movable optical element may, in embodiments, refract device light incident on the first face and/or the second face of the movable optical element, such that a beam tilt may be created. Hence, the refraction caused by the first face and/or the second face of the movable optical element may result in the beam of device light (slightly) tilting away from the optical axis (O). In embodiments, a tilt angle (a) between the optical axis (O) and the refracted beam of device light may be created. Especially, in such embodiments, the tilt angle (a) may be selected from the range of 1-45°, such as from the range of 2-30°, like from the range of 5-25°. Hence, by moving the movable optical element, in embodiments, a tilted beam of device light may be introduced, which may change the device light spot position on the luminescent material (arrangement). Especially, in embodiments, the device light spot position may be displaced by at least a radius of the device light spot. Furthermore, by rotating the movable optical element, the beam tilt created by refraction may change (due to the shape of the movable optical element), which may (also) change the device light spot position on the luminescent material (arrangement). Hence, in embodiments, by moving the movable optical element one or more of the device light spot size of the device light and the device light spot position of the device light on the luminescent material may be controlled.

Further, in embodiments, the luminescent material arrangement may also comprise a movable (especially a rotatable) element. In embodiments, the luminescent material arrangement may be provided as (or on a) wheel or disc. Hence, in embodiments the luminescent material arrangement may comprise a phosphor wheel. However, rotating rods may also be applied. Hence, in such embodiments, during operation of the light generating system (in an operational mode) the movable optical element and the phosphor wheel may rotate, such that over time different parts of the luminescent material may be irradiated by the device light. Hence, in some embodiments, the actuator may (also) be configured to rotate the movable element of the luminescent material arrangement, e.g. the phosphor wheel. Rotational frequencies may e.g. be selected from the range of 40-300 Hz, though other rotational frequencies may also be possible. Hence, typically, the duration of irradiating the luminescent material is much shorter (≥10x, more commonly ≥50x) than the duration of not irradiating the luminescent material.

In embodiments, the control system may be configured to control the actuator. Hence, in embodiments, the control system may control the actuator (and thereby in embodiments the rotational frequency). Further, in embodiments, the control system may be configured to control the one or more light generating devices, see also further below.

Further, in embodiments the luminescent material may be configured in thermal contact with a thermally conductive material. For instance, the luminescent material may be configured in thermal contact with a thermally conductive element.

A thermally conductive element may especially comprise thermally conductive material. A thermally conductive material may especially have a thermal conductivity of at least about 20 W/(m*K), like at least about 30 W/(m*K), such as at least about 100 W/(m*K), like especially at least about 200 W/(m*K). In yet further specific embodiments, a thermally conductive material may especially have a thermal conductivity of at least about 10 W/(m*K). In embodiments, the thermally conductive material may comprise one or more of copper, aluminum, silver, gold, silicon carbide, aluminum nitride, boron nitride, aluminum silicon carbide, beryllium oxide, a silicon carbide composite, aluminum silicon carbide, a copper tungsten alloy, a copper molybdenum carbide, carbon, diamond, and graphite. Alternatively, or additionally, the thermally conductive material may comprise or consist of aluminum oxide. In embodiments, the thermally conductive element may comprise one or more of a heatsink, a heat spreader, and a two-phase cooling device. In yet other embodiments, the thermally conductive element may be configured in thermal contact with one or more of a heatsink, a heat spreader, and a two-phase cooling device, and may e.g. transfer heat to such heatsink, heat spreader, or two-phase cooling device, via another thermally conductive element. An element may be considered in “thermal contact” with another element if it can exchange energy through the process of heat. Hence, the elements may be thermally coupled. In embodiments, thermal contact can be achieved by physical contact. In embodiments, thermal contact may be achieved via a thermally conductive material, such as a thermally conductive glue (or thermally conductive adhesive). Thermal contact may also be achieved between two elements when the two elements are arranged relative to each other at a distance of equal to or less than about 10 μm, though larger distances, such as up to 100 μm may be possible. The shorter the distance, the better the thermal contact. Especially, the distance is 10 μm or less, such as 5 μm or less, such as 1 μm or less. The distance may be the distanced between two respective surfaces of the respective elements. The distance may be an average distance. For instance, the two elements may be in physical contact at one or more, such as a plurality of positions, but at one or more, especially a plurality of other positions, the elements are not in physical contact. For instance, this may be the case when one or both elements have a rough surface. Hence, in embodiments in average the distance between the two elements may be 10 μm or less (though larger average distances may be possible, such as up to 100 μm).

As described above, in embodiments, the one or more light generating devices may be configured to generate device light, and the luminescent material may be configured to convert at least part of the device light into luminescent material light. Hence, in embodiments, the light generating system may be configured to generate system light. Especially, in embodiments, the system light may be visible light. Therefore, in embodiments, the system light may comprise one or more of the device light and the luminescent material light. Furthermore, in embodiments, the system light may especially be white light. However, in other embodiments, the system light may (also) comprise colored light.

As described above, the movable optical element may have a first face and a second face. In embodiments, the first face and the second face may define a thickness (d1) of the movable optical element. Especially, in embodiments, the thickness (d1) of the movable optical element may vary over the movable optical element. In such embodiments, for instance, the movable optical element may comprise a gradual decrease in thickness (d1) over the movable optical element. However, in other such embodiments, the movable optical element may comprise a stepwise decrease in thickness (d1) over the movable optical element. Yet, in other such embodiments, the movable optical element may comprise a sequence of increases and decreases in thickness (d1) over the movable optical element. Hence, in specific embodiments, the first face and the second face of the movable optical element may define a thickness (d1) of the movable optical element, wherein the thickness (d1) of the movable optical element may vary over the movable optical element, wherein the movable optical element may comprise a gradual decrease in thickness (d1) over the movable optical element, a stepwise decrease in thickness (d1) over the movable optical element, or a sequence of increases and decreases in thickness (d1) over the movable optical element.

Such embodiments may be beneficial as the variation in thickness may make the movable optical element more versatile for use in a variety of systems with different preferred settings. In some systems, it may be desired for the spot position of the device light to be further away from the optical axis (O), i.e., the tilted beam of device light may have a larger tilt angle (α) with the optical axis (O). Whereas in other systems, it may be desired for the spot position of the device light to be closer to the optical axis (O), i.e., the tilted beam of device light may have a smaller tilt angle (α) with the optical axis (O). With the embodiments as described above with a varying thickness of the movable optical element, the same element may be used in the different systems as mentioned. Hence, such embodiments may provide ease in manufacturing while maintaining versatility.

In embodiments, the thickness (d1) of the movable optical element may be selected from the range of 1-100 mm, such as from the range of 5-50 mm. Hence, in embodiments, a (local) distance between the first face and the second face of the movable optical element (i.e., the thickness (d1)) may have a minimum thickness (dₘᵢₙ) of at least 0.5 mm, such as at least 1 mm. In embodiments, the (local) distance between the first face and the second face of the movable optical element (i.e., the thickness (d1)) may have a maximum thickness (dₘₐₓ) of at most 100 mm, such as at most 60 mm, like at most 40 mm, especially at most 35 mm.

Further, the thickness (d1) may (thus) vary over the movable optical element. In embodiments, such variation in the thickness (d1) may comprise a gradual decrease in thickness (d1) over the movable optical element. Such a gradual decrease may occur with a constant slope or with a varying slope. Especially, in embodiments, the thickness (d1) of the movable optical element may comprise a gradual (or “smooth”) decrease with a constant slope over the movable optical element, i.e., the movable optical element may have one of a triangular, a polygonal or a prismatic cross-sectional shape. In such embodiments, the slope of the gradual decrease may especially be equal to the angle (θ1) relative to the plane (p). In other embodiments, the thickness (d1) of the movable optical element may comprise a gradual decrease with a varying slope over the movable optical element, i.e., the movable optical element may have one of a circular, a biconvex, a plano-convex, a biconcave, a plano-concave, a concavo-convex, or an oval-like cross-sectional shape. Especially, in such embodiments, a local slope of the gradual decrease may especially be equal to the angle (θ1) relative to the plane (p). Hence, in such embodiments, the movable optical element may have various (different) local slopes selected from the range of 1°≤θ1≤44°, see also above. The movable optical element may thus, in embodiments, (even) comprise a convex optical element, such as a convex lens. In other such embodiments, the movable optical element may comprise a concave optical element, such as a concave lens. In specific embodiments, the slope may vary in dependence of a distance to the rotational axis.

In embodiments, one of the first face and the second face may thus comprise a slope. Especially, in embodiments, one of the first face and the second face may comprise a radial slope. Further, in embodiments, the first face and the second face may both comprise a radial but different slope. Hence, in specific embodiments, one or more of the first face and the second face may comprise a radial and non-identical slope. In embodiments, (i) one or more of the first face and the second face comprise a radial slope, or (ii) both the first face and the second face comprise radial slopes, wherein the radial slopes are not identical. Hence, in embodiments a total angle of inclination of two radial slopes may be unequal to 0°.

Such embodiments may be beneficial as a difference in slopes between the first face and the second face may impose a tilt in direction on an incident beam of light, thusly redirecting the beam of light towards the luminescent material arrangement.

Herein, the term “radial” may refer to direction when, while looking at a cross-sectional plane of the movable optical element including both its axis of rotation (R) and a normal of its slope(s), moving away from the axis of rotation (R). For example, in embodiments, the first face may comprise a radial slope (θ1) selected from the range of 1°≤θ1≤44°, whereas the second face may not have a slope (or vice versa), i.e., θ1=0°. In such embodiments, the movable optical element may thus be a wedge shape. In another example, in embodiments, the first face and the second face may both comprise a radial slope (individually) selected from the range of 1°≤θ1≤44°, especially the first face and the second face may comprise a non-identical(/unequal) slope. Hence, in such embodiments, the movable optical element may be a(n irregular) trapezoid shape.

Additionally or alternatively, in embodiments, the movable optical element may comprise a stepwise decrease in thickness (d1) over the movable optical element. Especially, in embodiments, one of the first face and the second face may comprise n steps, whereas the other one of the first face and the second face may be straight and parallel to the plane (p). Therefore, in embodiments, n may be selected from the range of 2-50, such as from the range of 2-25, like at most 20. Each of the n steps may consist of a step run (or length) and a step rise (or height). In embodiments, at least one of the step run and the step rise may not be parallel to the plane (p). In some embodiments, both the step run and the step rise may not be parallel to the plane (p). Further, in embodiments, the step run and the step rise may have an angle relative to each other, i.e., a run-to-rise angle. Herein, the run-to-rise angle may be defined as the angle facing outward from the movable optical element starting from a point where the step run and the step rise intersect. In embodiments, the run-to-rise angle may be selected from the range of 135-175°, such as from the range of 140-160°. Further, in embodiments, each step may have a step run size (or length) and a step rise size (or height). Especially, the step run size and the step rise size may be individually selected from the range of 1-50 mm, such as from the range of 2-20 mm, like from the range of 5-10 mm. In embodiments, each step may have the same step run size and/or step rise size. However, in other embodiments, one or more of the step sizes may differ between the n steps. For example, in embodiments, the first face may comprise n=5 steps, the step run may be parallel to the plane (p) and may be 2 mm in size, the step rise may be 5 mm in size, and the run-to-rise angle may be 150°, whereas the second face may be straight and parallel to the plane (p)(, i.e., θ1=0°). Hence, in such embodiments, the run-to-rise angle may provide a nonzero angle (θ1)(here especially θ1=30°) of the n=5 rises of the first face (i.e., at least one of the first face and the second face) relative to the plane (p). Further, in embodiments, one of the first face and the second face may comprise n steps, whereas the other one of the first face and the second face may be straight but not parallel to the plane (p). Hence, in such embodiments, the second face may have a non-zero angle (θ1ₐ) relative to the plane (p). A boundary condition, in such embodiments, dictates that the non-zero angle (θ1ₐ) of the second face relative to the plane (p) is different from a non-zero angle (θ1_{b}) of (the runs and/or rises of) the first face, i.e., θ1ₐ≠θ1_{b}. Yet further, in embodiments, the first face and the second face may both comprise n steps. However, in such embodiments, the steps of the first face and the second face may especially be selected such that a beam of light incident on the first face, passing through the movable optical element and exiting through the second face may be redirected to provide the tilt angle (α) as described above. In yet other embodiments, the movable optical element may comprise a sequence of increases and decreases in thickness (d1) over the movable optical element. Hence, in such embodiments, the movable optical element may comprise a repeating pattern of increases and decrease in thickness (d1) over the movable optical element. For example, in embodiments, the movable optical element may comprise a sawtooth pattern at the first face and/or the second face of the movable optical element. Such a sawtooth pattern may thus comprise a sequence of constant slope increases from the minimum thickness (dₘᵢₙ) to the maximum thickness (dₘₐₓ) followed by a sudden decrease (or drop) back to the minimum thickness (dₘᵢₙ). In another example, in embodiments, the movable optical element may comprise a sinusoidal pattern at the first face and/or the second face of the movable optical element. In further embodiments, for example, the movable optical element may comprise a sequence of radial increases and decreases in thickness (d1) over the movable optical element, especially when the axis of rotation (R) of the movable optical element is offset from an optical axis (O) of an incident beam of device light (see also further below).

As can be derived from the above, the movable optical element may have a thickness, and hence, in embodiments, the movable optical element may have a three-dimensional shape. Especially, in embodiments, the movable optical element may have a wedge shape.

The wedge shaped movable optical element may thus comprise the first face and the second face, wherein the thickness (d1) between the first face and the second face may taper from the maximum thickness (dₘₐₓ) to the minimum thickness (dₘᵢₙ). In embodiments, such tapering of the wedge-shaped movable optical element may comprise a constant slope or a varying slope, such as described above. However, in embodiments, other shapes may be possible as well. For example, in embodiments, the movable optical element may have one of a (hemi)sphere shape, a prism shape, an ellipsoid shape, a saw-tooth shape, a square planar wedge shape and a flat-topped pyramid shape.

As described above, the device light may have an optical axis (O). In embodiments, the one or more light generating devices may be configured such that device light may be provided along the optical axis (O). In embodiments, the optical axis (O) and the axis of rotation (R) (of the movable optical element) may coincide. However, in other embodiments, the optical axis (O) and the axis of rotation (R) may be parallel but offset relative to each other, i.e., they may not coincide. Especially, in such embodiments, the spot of device light on the luminescent material may be provided in an elliptical trajectory. In yet other embodiments, the optical axis (O) and the axis of rotation (R) may not be parallel. In some embodiments, even, the axis of rotation (R) may be perpendicular to the optical axis (O). In specific embodiments, the one or more light generating devices may be configured such that device light propagating to the luminescent material arrangement may have an optical axis (O) coinciding with the axis of rotation (R) of the movable optical element. Such embodiments may be beneficial as configuring different elements on the same axis may provide a compact light generating system. Herein, the term “optical axis” may be defined as an imaginary line that defines the path along which light propagates through a system towards the luminescent material arrangement, here especially the luminescent material. Especially, the optical axis may coincide with the direction of the light with the highest radiant flux. Further, in specific embodiments, the movable optical element and the actuator may be configured, such that when rotating the movable optical element (about the axis of rotation (R)) the device light spot position may have a circular or non-circular, such as oval, trajectory over the luminescent material arrangement. Such embodiments may provide local periods of non-illumination alternated with periods of illumination on the luminescent material. Such alternating periods may allow the luminescent material to cool during such local periods of non-illumination and may thus improve the thermal capacity of the system. As a result, the lifespan, efficiency, and maximum irradiance of the luminescent material and subsequently of the light generating system may be improved.

Especially, in embodiments, the device light spot position may have a circular trajectory over the luminescent material (arrangement). In other embodiments, the device light spot position may have a non-circular, such as oval, trajectory over the luminescent material (arrangement). In yet other embodiments, the device light spot position may have a line-shaped trajectory over the luminescent material (arrangement), where the device light spot may move up and down the line. Especially, in such embodiments, the line may be one of a straight line or a curved line, such as a half circle.

Not only the trajectory of the spot of device light over the luminescent material arrangement may be relevant. In embodiments, the luminescent material of the luminescent material arrangement may also (spatially) vary (over the luminescent material arrangement). For example, in embodiments, the luminescent material of the luminescent material arrangement may have a spatially varying luminescent material concentration. Further, in embodiments, the luminescent material of the luminescent material arrangement may have a spatially varying luminescent material thickness. Yet further, in embodiments, the luminescent material of the luminescent material arrangement may have a spatially varying type of luminescent material. Hence, in specific embodiments, the luminescent material of the luminescent material arrangement may have spatially varying properties selected from luminescent material concentration, luminescent material thickness, and type of luminescent material. Such embodiments may be beneficial as varying the type of luminescent material may for example change the color or spectral power distribution of the luminescent material light and thus of the system light. Hence, by (spatially) varying the type of luminescent material in the light generating system a system may be provided with a wide array of color possibilities. Furthermore, by (spatially) varying the thickness of the luminescent material, further improvement in thermal management of the light generating system may be provided. Yet further, by (spatially) varying the luminescent material concentration variations in the radiant flux of the system may be provided.

In embodiments, the luminescent material of the luminescent material arrangement may have spatially varying properties. Hence, the properties of the luminescent material may be different at different positions in the luminescent material arrangement. Such varying properties may, in embodiments, comprise one or more of luminescent material concentration, thickness and type. Especially, in embodiments, the concentration of the luminescent material may vary over the luminescent material arrangement, for example, due to admixing of reflective material with the luminescent material in different ratios. More luminescent material relative to reflective material may lead to more conversion of device light, i.e., a higher conversion rate. On the contrary, more reflective material relative to luminescent material may lead to more reflection of the device and/or luminescent material light, i.e., a higher radiant flux. Additionally or alternatively, in embodiments, the concentration of the luminescent material may vary over the luminescent material arrangement, for example, due to admixing of different types of luminescent material, see also further below. Further, in embodiments, the thickness of the luminescent material may vary over the luminescent material arrangement, for example, outer edges of the luminescent material may be provided with a thicker layer of material than the center (or inner edges) such that the center (or inner edges) may have a lower thermal load. Additionally, in embodiments, varying the thickness of the luminescent material of the luminescent material arrangement may provide an inclined material surface (or slope). Such an inclined surface may be used, so that a direction of maximum emission of luminescent material light from the luminescent material may correspond to a direction of device light incident on that spot of luminescent material.

Spatial variations in the luminescent material arrangement may thus be provided. In embodiments, such variations may be exploited to control a spectral power distribution of the system light. Especially, in embodiments, the control system may be configured to control the actuator, such that the trajectory of the spot of device light on the luminescent material may be controlled, and thus the irradiation of the spatial variations in the luminescent material arrangement may be controlled. Hence, in specific embodiments, the control system may be configured to control a spectral power distribution of the system light by controlling the actuator.

For example, in embodiments, by controlling the actuator, the rotational frequency of the movable optical element may be controlled. If, in such embodiments, the luminescent material arrangement may comprise spatial variations in e.g. luminescent material type, a change in rotational frequency may affect the spectral power distribution of the system light.

In embodiments, aside from the above mentioned components, the light generating system may comprise additional elements. Especially, in embodiments, the light generating system may further comprise a diffuser element. In such embodiments, the light generating system may be configured to direct, in an operational mode of the light generating system, part of the device light to the luminescent material arrangement and part of the device light to the diffuser element. The diffuser element may, in embodiments, be configured to diffuse at least part of the device light received by the diffuser element. Hence, thereby, the diffuser element may provide diffused device light. Therefore, in embodiments, the light generating system may be configured to generate system light comprising one or more of (device light,) the diffused device light, and the luminescent material light. Hence, in specific embodiments, the light generating system may further comprise a diffuser element, wherein the light generating system may be configured to direct in an operational mode of the light generating system part of the device light to the luminescent material arrangement and part of the device light to the diffuser element; wherein the diffuser element may be configured to diffuse at least part of the device light received by the diffuser element thereby providing diffused device light; and wherein the light generating system may be configured to generate system light comprising one or more of the diffused device light and the luminescent material light. Such embodiments may be beneficial as, by using diffuse (reflected) laser light, a light engine with high robustness concerning eye safety may be realized.

Herein, the term “diffuser element” may refer to an element that diffuses or scatters light, such that soft light may be transmitted and/or reflected. In embodiments, such a diffuser element may comprise a diffusing material, such as one or more selected from the group comprising a glass, a polymeric material, a fabric, and a gel. An example of a reflective diffuser element may be a metallic coated glass diffuser showing 95-98% reflectance.

In embodiments, the light generating system may comprise one or more operational modes. In some embodiments, there may only be a first operational mode, and in other embodiments there may be a first operational mode, a second operational mode, etc. etc. Especially, herein the term “a first operational mode” and similar terms may also refer to one or more, such as a plurality of first operational modes. Hence, in embodiments, there may be a plurality of (first) operational modes.

In embodiments, the light generating system may be configured to direct, in an operational mode of the light generating system, part of the device light to the luminescent material arrangement and part of the device light to the diffuser element. Hence, in embodiments, part of the device light may be incident on the luminescent material arrangement and another part of the device light may be incident on the diffuser element. In embodiments, the device light may be provided to the luminescent material arrangement and the diffuser element in a ratio. Especially, in embodiments, the ratio may be selected from the range of 0% of the device light to the luminescent material arrangement and 100% of the device light to the diffuser element to 100% of the device light to the luminescent material arrangement and 0% of the device light to the diffuser element. More especially, in embodiments, the ratio may be selected from the range of 20% of the device light to the luminescent material arrangement and 80% of the device light to the diffuser element to 80% of the device light to the luminescent material arrangement and 20% of the device light to the diffuser element. For example, in embodiments, the ratio may be 55-85%, such as 65%, of the device light directed to the luminescent material arrangement and 15-45%, such as 35%, of the device light directed to the diffuser element.

In embodiments, at least part of the device light that reaches the diffuser element may be diffused to provide diffused device light. Especially, in embodiments, at least 60% of the second device light that reaches the diffuser element may be diffused, such as at least 70%, like at least 80%, especially at least 90%. Hence, in embodiments the diffuser element may especially be configured to diffuse (by reflection and/or transmission) at least part of the device light received by the diffuser element thereby providing diffused device light.

The diffused device light may, in embodiments, be combined with (for example through additional optics) the luminescent material light to provide (white) system light. Therefore, in embodiments, the light generating system may be configured to generate system light comprising one or more of device light, diffused device light, and luminescent material light.

In specific embodiments, one or more of the following may apply: (a) the luminescent material may be operated in the transmissive mode and the (b) the diffuser element as described above may be operated in the transmissive mode. In embodiments, the luminescent material may be operated in the transmissive mode and the diffuser element may be operated in the reflective mode, i.e., a hybrid configuration. In such embodiments, one or more additional (combiner) optics, such as a reflector or a (dichroic and/or polarizing) beam splitter, may be applied to combine the transmitted luminescent material light and the reflected diffused device light. Similarly, in other embodiments, the luminescent material may be operated in the reflective mode and the diffuser element may be operated in the transmissive mode, i.e., a hybrid configuration. In such embodiments (also), one or more additional (combiner) optics, such as a reflector or a (dichroic and/or polarizing) beam splitter, may be applied to combine the reflected luminescent material light and the transmitted diffused device light. Further, in embodiments, the luminescent material and the diffuser element may both be configured in the transmissive mode. For example, in embodiments, the luminescent material arrangement may comprise a track comprising both luminescent material and the diffuser element, e.g., the luminescent material and the diffuser element may be alternatingly configured in the same track. In such embodiments, additional optics, such as beam combining and beam homogenizing optics, may be applied. However, other embodiments may be possible as well. For example, in embodiments, the luminescent material arrangement and the diffuser element may both be configured in the transmissive mode, and additional optics, such as reflectors and/or (dichroic and/or polarizing) beam splitters, may be applied to combine the transmitted luminescent material light and the transmitted diffused device light.

As indicated, in embodiments, the light generating system may comprise additional optics. The light generating system further comprises central optics, a polarization changing element, and a diffuser element. The one or more light generating devices of the light generating system are configured to generate polarized device light having a controllable polarization. The light generating system is configured to direct, in an operational mode of the light generating system, part of the device light via the central optics to the luminescent material arrangement and part of the device light via the central optics to the diffuser element. The diffuser element is configured to diffuse at least part of the device light received by the diffuser element while maintaining at least part of the polarization of the device light. The diffuser element is configured to provide diffused device light, while maintaining at least part of the polarization of the device light. Further, in such embodiments, the diffuser element may be configured in the reflective mode. The polarization changing element is configured in an optical path of the device light between the central optics and the diffuser element, wherein Especially, in embodiments, the polarization changing element may comprise one or more of a λ/4 waveplate and a Faraday rotator. The central optics comprises (i) a central optics polarizing beam splitter, and (ii) a central optics dichroic beam splitter, wherein the central optics polarizing beam splitter is configured to transmit and/or reflect at least part of the device light in dependence of its polarization, or the central optics dichroic beam splitter is configured (a) to transmit or reflect at least part of the device light, and (b) to reflect or transmit at least part of the luminescent material light. The control system is configured to control the polarization of the device light. The light generating system is configured to generate system light comprising one or more of the diffused device light and the luminescent material light. Therefore, in embodiments, the light generating system may be configured to generate system light comprising one or more of the diffused device light, received via the central optics, and the luminescent material light, received via the central optics. Hence, in specific embodiments, the light generating system may further comprise central optics, a polarization changing element, and a diffuser element, wherein: (A) the one or more light generating devices may be configured to generate polarized device light having a controllable polarization; (B) the light generating system may be configured to direct in an operational mode of the light generating system part of the device light via the central optics to the luminescent arrangement and part of the device light via the central optics to the diffuser element; (C) the diffuser element may be configured to diffuse at least part of the device light received by the diffuser element thereby providing diffused device light while maintaining at least part of the polarization of the device light; (D) the polarization changing element may be configured in an optical path of the device light between the central optics and the diffuser element; wherein the polarization changing element may comprises one or more of a λ/4 waveplate and a Faraday rotator; (E) the central optics may comprise (i) a central optics polarizing beam splitter, and (ii) a central optics dichroic beam splitter; wherein the central optics polarizing beam splitter may be configured to transmit and/or reflect at least part of the device light in dependence of its polarization; and
wherein the central optics dichroic beam splitter may be configured (a) to transmit or reflect at least part of the device light, and (b) to reflect or transmit at least part of the luminescent material light; (F) the control system may be configured to control the polarization of the device light; and (G) the light generating system may be configured to generate system light comprising one or more of the diffused device light and the luminescent material light.

Such embodiments may be beneficial as operating the luminescent material arrangement and the diffuser in a reflective mode may provide a more fail-safe system, by which it can be prevented that direct laser beams emit from the system in case the luminescent component or a diffusing component would fail (e.g. break, fall off, etc.). Further, such a system may provide the benefit of controllability of one or more of the spectral power distribution and the radiant flux of the system light, through manipulation of the central optics and the polarization changing element. Thanks to the use of a (partially) polarizing beam splitter, the light engine shows high efficiency.

As briefly mentioned above in embodiments, the device light may be unpolarized light. However, in (other) embodiments the device light may comprise one or more of polarized light having a p polarization and polarized light having an s polarization. Optionally, in embodiments, the device light may be elliptically or circularly polarized. Hence, in embodiments, the one or more light generating devices may be configured to generate polarized device light. Further, in specific embodiments, the polarization of the device light may be controllable, such as using one or more of (i) polarization control optics, and (ii) using two or more light generating devices generating device light having different (linear, circular or elliptical) polarizations. Further, in embodiments, a degree of polarization of the polarized light may be controlled. In specific embodiments, the control system may (further) be configured to control the polarization of the device light, see also above and further below.

Especially, in embodiments the degree of polarization may be defined as a percentage of the p-polarized light or the s-polarized light relative to the total of s-polarized light and p-polarized light. For determining the percentages, the angular luminance of the device light having s polarization and the angular luminance of the device light having p polarization may be applied. For instance, the device light may have 20% s polarization and 80% p polarization. For the angular luminance, see e.g. Blom, S. et al., Towards a polarized light-emitting backlight: Micro-structured anisotropic layers, DOI-10.1889/1.1827869, Journal of the Society for Information Display, September 2002, p. 209-213. Instead of the angular luminance, also the luminance may be applied. Yet, (in general) the term “degree of polarization” is known in the art. Especially, in embodiments the degree of polarization may be defined as a percentage of the p-polarized light and/or the s-polarized light relative to the total of p-polarized light and s-polarized light. Measurement of the degree of polarization is known in the art, and may be based on Stokes parameters.

Herein, instead of the term “s-polarized light”, and similar terms, also the term “linear s-polarized light” may be applied. Further, especially, instead of the term “p-polarized light”, and similar terms, also the term “linear p-polarized light” may be applied.

As can be derived from the above, the system may comprise a plurality of optics. Some optics may not (further) be described in detail and will be obvious to a person skilled in the art. Some optics, however, are described in further detail here below.

The central optics may especially be used to route the device light, the luminescent material light, and the diffused device light. Part of the device light may especially reach the luminescent material, and at least part of the luminescent material light may be able to escape from the system. Similarly, part of the device light may especially reach the diffuser element, and at least part of the diffused device light may be able to escape from the system. For this purpose, the central optics may-amongst others-be applied. Especially, the central optics may be configured, in an operational mode of the light generating system, (a) to transmit or reflect at least part of the device light, (b) to reflect or transmit at least part of the luminescent material light, and (c) to reflect or transmit at least part of the diffused device light. Hence, following propagation of the device light from the one or more light generating devices, it may propagate-amongst others-via the central optics to the luminescent material and/or the diffuser element. When irradiating the luminescent material, at least part of the device light may be converted into luminescent material light. Following the propagation of the luminescent material light from the luminescent material, it may propagate-amongst others-via the central optics to the external of the system. Similarly, when irradiating the diffuser element, at least part of the device light may be diffused to provide diffused device light. Following the propagation of the diffused device light from the diffuser element, it may propagate-amongst others-via the central optics to the external of the system.

In embodiments, the device light incident on the diffuser element may thus be diffused by the diffuser element. Especially, in embodiments, the diffuser element may especially be configured to diffuse at least part of the device light received by the diffuser element, such as essentially all of the device light received by the diffuser element. More especially, in embodiments, the diffuser element may be configured to diffuse at least part of the device light received by the diffuser element, thereby providing diffused device light while maintaining at least part of the polarization of the device light. Hence, the diffused device light propagating from the diffuser element may have substantially the same, such as exactly the same, polarization as the device light incident on the diffuser element. In embodiments, the diffuser element may especially be configured in the reflective mode.

As indicated above, a polarization changing element may be configured in an optical path between the central optics and the diffuser element. Especially, the polarization changing element may be configured to change s-polarized light or p-polarized light to circular polarized light. The diffuser element may change the direction of the polarized light, but the circular polarized light may essentially stay circular polarized light. At least part of the diffused light, having circular polarization, will propagate from the diffuser element to the polarization changing element, and then be converted to (diffused) s-polarized light and/or (diffused) p-polarized light, which may further propagate to the central optics. Therefore, in some embodiments, the polarization changing element may comprise a λ/4 waveplate; wherein the polarization changing element is especially configured in an optical path of the device light between the central optics and the diffuser element. In this way, p-polarized light can be converted in diffused s-polarized light, and s-polarized light can be converted in diffused p-polarized light.

Especially, the polarization changing element may be an element that induces a 90° phase shift between the two orthogonal linear polarization components (s and p) of the light. The most common way is to use birefringent material (birefringent rotators), such as a quarter-wave plate. An alternative may be to use the Faraday effect, in which case the phase shift is caused by an applied magnetic field (Faraday rotators). Another alternative may be to use any component or set of components resulting in an up to 180° relative phase shift of one polarization versus the other polarization. In embodiments, such phase shift may be the result of any one of birefringent, electro-optical, thermo-optical, magneto-optical or any other principle known in the art.

As indicated above, the system may (also) comprise central optics. The term “central optics” is applied as essentially all light, i.e. the device light, the diffused device light, and the luminescent material light may, in embodiments, only escape from the system via the central optics. Further, the device light may only reach the diffuser element or the luminescent material via the central optics. In embodiments, the central optics comprises (i) a central optics polarizing beam splitter, and (ii) a central optics dichroic beam splitter. Hence, the term “central optics polarizing beam splitter” refers to a polarizing beam splitter comprised by the central optics. Likewise, the term “central optics dichroic beam splitter” refers to a dichroic beam splitter comprised by the central optics. In specific embodiments, the central optics polarizing beam splitter may be configured to transmit and/or reflect at least part of the device light in dependence of its polarization. Further, in specific embodiments, the central optics dichroic beam splitter may be configured to (a) to transmit or reflect at least part of the device light, and (b) to reflect or transmit at least part of the luminescent material light. Especially, the central optics polarizing beam splitter, and the central optics dichroic beam splitter are configured such that at least part of the diffused second device light reaching the central optics, and at least part of the luminescent material light reaching the central optics may escape from the system in essentially the same directions. Especially, this may imply that one of the diffused device light and the luminescent material light is transmitted by the central optics and the other one of the diffused second device light and the luminescent material light is reflected by the central optics. Hence, the system may especially be configured such that diffused device light propagating to the central optics and luminescent material light propagating to the central optics have a mutual angle of (about) 90°. Hence, the central optics may in embodiments comprise at least two different functionalities, which may e.g. be realized by using two optical components, or by using a single optical component with two different functional layers (or sets of layers)(e.g. surface configurations or coatings/dichroic layer stacks; or by integration of both functions in a single surface layer or coating (stack of dichroic layers)). Therefore, in embodiments, the central optics may comprise a single optical component having polarizing beam splitting functionality and dichroic beam splitting functionality, or comprises two (or more) optical components, one having polarizing beam splitting functionality and one having dichroic beam splitting functionality.

Especially, in embodiments, device light reaching the central optics may be reflected and/or transmitted by the central optics polarizing beam splitter. Especially, (a) the polarization of the device light and (b) the central optics polarizing beam splitter may be configured such that (i) at least part of the device light propagates to the diffuser element (and is diffused at the diffuser elements), and (ii) at least part of the diffused device light may escape from the system via the central optics. This may e.g. imply that the central optics polarizing beam splitter is at least partially transmissive for a first polarization and at least partially reflective for a second polarization, or, the other way around, this may e.g. imply that the central optics polarizing beam splitter is at least partially transmissive for a second polarization and at least partially reflective for a first polarization.

The central optics polarizing beam splitter (comprised by the central optics) may be configured to transmit at least part of the s-polarized light and reflect at least part of the s-polarized light. Likewise, it may be configured to reflect at least part of the p-polarized light and transmit at least part of the p-polarized light. The percentage of transmission and reflection for the respective polarization may be defined by the central optics polarizing beam splitter. An example of such partially polarizing beam splitter is e.g. a broadband partially polarizing beam splitter that at 450 nm transmits about 77% of p-polarized light and substantially no s-polarized light, while it reflects ca. 10% of p-polarized light and 86% of s-polarized light.

Especially, in embodiments the central optics polarizing beam splitter may be configured such that for one polarization the transmittance is not complete, and thus may be partly reflected, whereas for the other polarization, the reflectance may be relatively high, and thus may have a small transmission or essentially no transmission. However, this may also be the other way around. Hence, in embodiments the central optics polarizing beam splitter may be configured to transmit a larger part of the p-polarized light than a part of the s-polarized that is reflected. In other embodiments, the central optics polarizing beam splitter may be configured to transmit a larger part of the s-polarized light than a part of the p-polarized that is reflected. In yet other embodiments, the central optics polarizing beam splitter may be configured to reflect a larger part of the s-polarized light than a part of the p-polarized that is transmitted. In yet other embodiments, the central optics polarizing beam splitter may be configured to reflect a larger part of the p-polarized light than a part of the s-polarized that is transmitted. Hence, the central optics polarizing beam splitter may especially be a partially polarizing beam splitter.

In embodiments, luminescent material light reaching the central optics may be reflected or transmitted at the central optics dichroic beam splitter. The central optics dichroic beam splitter may be configured such that (a) diffused device light may be reflected at the central optics dichroic beam splitter when the central optics dichroic beam splitter is configured to transmit the luminescent material light, and/or (b) diffused device light may be transmitted at the central optics dichroic beam splitter when the central optics dichroic beam splitter is configured to reflect the luminescent material light. Examples of such dichroic beam splitter are e.g. a short-pass cut-off dichroic plate, or a long-pass cut-off dichroic plate. In specific embodiments, the central optics dichroic beam splitter may be designed for a 45° angle of incidence (of the device light).

Especially, a peak wavelength of the device light and the luminescent material may be selected such that the peak wavelength of the device light and the centroid wavelength of the luminescent material light are spectrally positioned at two opposite sides of a cut-on/cut-off wavelength of a dichroic filter comprised by the central optics. Hence, the peak wavelength of the device light and the centroid wavelength of the luminescent material, may be selected such, that the central optics dichroic beam splitter may spectrally substantially separate them, and essentially transmit one and essentially reflect the other.

Therefore, in embodiments the system may especially be configured such that diffused device light and luminescent material light propagating orthogonal to the central optics may escape (in the same direction) from the system via the central optics to provide system light comprising the diffused device light and luminescent material light. System light may escape from a light exit of the system (see also above).

In embodiments, the central optics dichroic beam splitter may be configured (a) to transmit or reflect at least 70%, more especially at least 80% of the device light received by the central optics dichroic beam splitter, such as especially at least about 90%. Alternatively or additionally, the central optics dichroic beam splitter may be configured (b) to reflect or transmit at least (b1) 70%, more especially at least 80% of the luminescent material light received by the central optics dichroic beam splitter, such as especially as at least 90% of the luminescent material light received by the central optics dichroic beam splitter and (b2) at least 70%, more especially at least 80%, such as at least 90% of the device light received by the central optics dichroic beam splitter. Note that when the central optics dichroic beam splitter is configured to reflect at least part of the device light, it may also be configured to transmit at least part of the luminescent material light and at least part of the diffused device light.

Furthermore, in embodiments, the control system may be configured to control the one or more light generating devices. Especially, in embodiments, the control system may be configured to control the polarization of the device light, e.g., through controlling the one or more light generating devices. In other embodiments, the control system may be configured to control the polarization of the device light through controlling a polarization control element, see also further below.

Hence, in specific embodiments the light generating system may be configured to provide system light comprising one or more of (device light,) diffused device light, received via the central optics, and luminescent material light, received via the central optics.

Further, in embodiments, the light generating system may comprise a polarization control element. Especially, the polarization control element may be configured to control the polarization of the device light received by the polarization control element. In such embodiments, the control system may especially be configured to control the polarization control element. Additionally or alternatively, in embodiments, the one or more light generating devices of the light generating system may comprise two different types of light generating devices. Especially, in such embodiments, the light generating devices may differ in the type of polarization of the device light they generate. Further, in such embodiments, the light generating system may comprise a first polarizing beam splitter. Especially, the first polarizing beam splitter may be configured downstream of the two different types of light generating devices and upstream of the central optics. The first polarizing beam splitter may especially be configured to transmit s-polarized light or p-polarized light, and the reflect p-polarized light or s-polarized light. In such embodiments, the control system may (also) be configured to control the two different types of light generating devices. Hence, in specific embodiments, one or more of the following applies: (a) the light generating system may further comprise a polarization control element, wherein the polarization control element may be configured to control polarization of the device light received by the polarization control element; and wherein the control system may be configured to control the polarization control element; and (b) the one or more light generating devices may comprise two different types of light generating devices, differing in the type of polarization of the device light they generate; wherein the light generating system may further comprise a first polarizing beam splitter, wherein the first polarizing beam splitter may be configured downstream of the two different types of light generating devices and upstream of the central optics; and wherein the first polarizing beam splitter may be configured to transmit s-polarized light or p-polarized light, and to reflect p-polarized light or s-polarized light; and wherein the control system may be configured to control the two different types of light generating devices.

Such embodiments may provide the benefit of controllability of one or more of the spectral power distribution and the radiant flux of the system light, through manipulation of the polarization control element or the two different types of light generating devices and/or the first polarizing beam splitter.

Downstream of the one or more light generating devices, the polarization control element may be configured. Especially, the polarization control element may be configured in an optical path of the device light between the one or more light generating devices and the central optics. With the polarization control element, the polarization of the device light may be controlled. For instance, with a (rotatable) λ/2 retarder (or “half wave plate”, see also below), in embodiments, polarizations between fully s polarization and fully p polarization may be chosen. In this way, the ratio between the device light that is directed via the central optics to the diffuser element and device light that is directed via the central optics to the luminescent material may be controlled. Note that in embodiments in some operational modes, essentially all device light may be directed via the central optics to the diffuser element. In embodiments, in some other operational modes, essentially all device light may be directed via the central optics to luminescent material. Yet, in embodiments in other operational modes, part of the device light may be directed via the central optics to diffuser element and part of the device light may be directed via the central optics to the luminescent material. Hence, (a) the polarization control element may be used to control the ratio of the polarizations of the device light, and (downstream thereof) the central optics routes, dependent upon the polarization of the device light, the further propagation of the device light (see further also below).

In embodiments, by rotating the polarization control element the polarization of the device light may be controlled. As indicated herein, especially the device light, upstream of the polarization control element, may be linearly polarized, like s-polarized or p-polarized. Optionally, the device light may be a combination of s-polarized light and p-polarized light. For instance, the combination of polarization control element and light source may provide device light, downstream of the polarization control element, having at least two polarizations selected from: essentially p-polarized, essentially s-polarized, and a combination of p-polarized and s-polarized. Note that in embodiments by rotating the polarization control element, a ratio between p-polarized and s-polarized may be controlled. For instance, would the device light be p-polarized light, by rotating the polarization control element, the contribution of p-polarized light may be reduced and the contribution of s-polarized may be increased, until essentially s-polarized light is obtained. Hence, in dependence of the rotational angle, the polarization of the device light may be controlled. In embodiments, a degree of polarization of the device light may be controlled by the polarization control element. The system may comprise an actuator configured to control the polarization control element. The control system may control the actuator for controlling the polarization control element. In embodiments, the afore-mentioned angle may be fixed during operation (i.e. not controllable during operation), and in other embodiments, this angle may be controlled (by the control system). Especially, herein the polarization of the device light propagating to the central optics is controllable (with the polarization control element).

In embodiments, the polarization control element may comprise a rotatable birefringent rotator. More especially, the (rotatable) birefringent rotator comprises a λ/2 waveplate (with reference to a device light center wavelength, i.e., wavelength at the center of the full width half maximum). However, other phase-shift inducing components for the two linear orthogonal polarization components which can change the ratio of transmitted versus reflected light may also be applied. For example, an alternative may be to use any component or set of components resulting in an (arbitrary) phase shift up to 360° of one polarization versus the other polarization. In embodiments, such phase shift may be the result of any one of birefringent, electro-optical, thermos-optical, magneto-optical or any other principle known in the art. With a half-wavelength plate, s-polarized light can be transformed for 0-100% into p-polarized light. With a quarter-wavelength plate that may be only 0-50%. With a ⅜th-wavelength plate 0-75%, and with a ⅛th-wavelength plate 0-25%. So, a half-wavelength plate may give full flexibility (and independence of the actual polarization direction of the source), while the other options may give more limitations, both in terms of the fraction of light that can be transformed into required polarized components and in terms of the orientation of the polarization direction of the source.

In specific embodiments, the polarization control element may be configured fixed. In such embodiments, essentially only a (single) first operational mode may be available, unless other parameters are variable (like the radiant flux of the device light). In other embodiments, the polarization control element may be configured controllable, especially rotatable. In such embodiments, by rotating the polarization control element, the spectral power distribution of the system light may be controlled. In such embodiments, a plurality of first operational modes may be available, with different spectral power distributions.

In order to further increase input power and/or to provide a further control option, more than one type of light generating device may be applied, wherein at least two types differ in the polarized light they generate. For instance, in embodiments one of the types may e.g. have primarily s-polarized light, and another one of the types may e.g. have primarily p-polarized light. In embodiments, a first polarizing beam splitter may be used to combine the beams of the two types of light generating devices. Especially, the first polarizing beam splitter may be configured downstream of the two different types of light generating devices and upstream of the central optics. In embodiments, the first polarizing beam splitter may be configured to transmit s-polarized light or p-polarized light, and to reflect p-polarized light or s-polarized light. Hence, in embodiments, the first polarizing beam splitter may be configured to transmit s-polarized light, and to reflect p-polarized light. In other embodiments, the first polarizing beam splitter may be configured to transmit p-polarized light, and to reflect s-polarized light. Therefore, in embodiments, the control system may (also) be configured to control the two different types of light generating devices(, such that the polarization of the device light may be controlled).

Hence, the term “light generating devices” may also refer to one or more primary light generating devices and one or more secondary light generating devices. Therefore, in embodiments the system may comprise a primary light generating device and a secondary light generating device, wherein the device light of one of the primary light generating device and the secondary light generating device, comprises more s-polarized than the other one of the primary light generating device and the secondary light generating device. One or more primary light generating devices, especially a plurality of primary light generating device, may be configured in a laser bank (or “a laser block”), i.e., the primary light generating devices comprise laser diodes. Alternatively or additionally, one or more secondary light generating devices, especially a plurality of secondary light generating devices may be configured in a laser bank (or “a laser block”), i.e., the secondary light generating devices comprise laser diodes. The laser banks may be different laser banks, though a configuration in the same laser bank may also be possible. In embodiments, laser banks (or “laser blocks”) may (thus) be applied. Laser banks may also be used to boast the input power. Therefore, in embodiments the system may comprise a plurality of light generating devices configured to generate the device light, wherein two or more of the light generating devices may comprise laser light sources configured in a laser bank.

Additionally or alternatively, in embodiments, the one or more light generating devices of the light generating system may comprise two different types of light generating devices, differing in a spectral power distribution of the device light they generate. In such embodiments, the light generating system may comprise a first dichroic beam splitter. Especially, the first dichroic beam splitter may be configured downstream of the two different types of light generating devices and upstream of the central optics. The first dichroic beam splitter may especially be configured (a) to transmit or reflect at least part of the device light of a first type, and (b) to reflect or transmit at least part of the device light of a second type. Further, in such embodiments, the control system may (also) be configured to control the two different types of light generating devices. Hence, in specific embodiments, the one or more light generating devices may comprise two different types of light generating devices, differing in a spectral power distribution of the device light they generate; wherein the light generating system may further comprise a first dichroic beam splitter, wherein the first dichroic beam splitter may be configured downstream of the two different types of light generating devices and upstream of the central optics; wherein the first dichroic beam splitter may be configured (a) to transmit or reflect at least part of the device light of a first type, and (b) to reflect or transmit at least part of the device light of a second type; wherein the control system may be configured to control the two different types of light generating devices.

Hence, in order to further increase input power and/or to provide a further control options, more than one type of light generating device may be applied. Especially at least two types of light generating devices may differ in the spectral power distribution they provide. One of the types may have a different wavelength than the other one, such as a different peak wavelength, and a dichroic beam splitter may be used to combine the beams of the two types of light generating devices.

In embodiments, primary light generating devices may be configured to generate device light of a first type and secondary light generating devices may be configured to generate device light of a second type. Hence, the device light of the first type and device light of the second type may have different spectral power distributions and/or different color points. In specific embodiments, colors or color points of a first type of light and a second type of light may be different when the respective color points of the first type of light and the second type of light differ with at least 0.01 for u′ and/or with at least 0.01 for v′, even more especially at least 0.02 for u′ and/or with at least 0.02 for v′. In yet more specific embodiments, the respective color points of first type of light and the second type of light may differ with at least 0.03 for u′ and/or with at least 0.03 for v′. Here, u′ and v′ are color coordinates of the light in the CIE 1976 UCS (uniform chromaticity scale) diagram. Spectral power distributions of different sources of light having centroid wavelengths differing at least 10 nm, such as at least 20 nm, or even at least 30 nm may be considered different spectral power distributions, e.g. different colors. In general, the differences in centroid wavelengths will not be larger than about 400 nm, such as not more than 350 nm. Note that for the first type of device light and the second type of device light, the differences in centroid wavelengths may be relatively small, such as selected from the range of 3-50 nm, such as selected from the range of 5-50 nm, like selected from the range of 5-40 nm. Hence, in embodiments the difference in centroid wavelength of the first type of device light and second type of device light herein may in embodiments be no larger than about 50 nm.

In embodiments, the device light of the first type and the device light of the second type may have a wavelength selected from the blue wavelength range (see also above), more especially have peak wavelengths selected from the blue wavelength range.

In embodiments, a first dichroic beam splitter may be used to combine the beams of the two types of light generating devices. Especially, the first dichroic beam splitter may be configured downstream of the two different types of light generating devices and upstream of the central optics. Note that, in some embodiments, the light generating system may comprise both a first polarizing beam splitter and a first dichroic beam splitter. In such embodiments, one of the following may apply: (i) the first polarizing beam splitter may be configured downstream of the first dichroic beam splitter, or (ii) the first polarizing beam splitter may be configured upstream of the first dichroic beam splitter. In embodiments where the light generating system also comprises the polarization control element, the polarization control element may be configured either upstream or downstream of the first dichroic beam splitter. In embodiments, the first dichroic beam splitter may be configured to transmit or reflect at least part of the device light of the first type. Especially, in embodiments, the first dichroic beam splitter may be configured to transmit or reflect at least 70%, such as at least 80%, like at least 90%, including 100% of the device light of the first type. Further, in embodiments, the first dichroic beam splitter may be configured to reflect or transmit at least part of the device light of the second type. Especially, in embodiments, the first dichroic beam splitter may be configured to reflect or transmit at least 70%, such as at least 80%, like at least 90%, including 100% of the device light of the second type. For example, in embodiments, the first dichroic beam splitter may be configured to transmit at least 90% of device light of the first type and to reflect at least 90% of device light of the second type. Therefore, in embodiments, the control system may (also) be configured to control the two different types of light generating devices (such that the spectral power distribution of the device light may be controlled).

Similarly, in embodiments, the luminescent material may comprise at least two different luminescent materials configured to provide luminescent material light having different spectral power distributions. Especially, in embodiments, the at least two different luminescent material may be configured at different locations, i.e., the at least two different luminescent materials may be spatially separated. Further, as can be derived from the above, the term “different luminescent materials” may refer to luminescent materials that are different, or to two compositions, each including at least one luminescent material in common, but wherein the compositions differ. For instance, a first luminescent material comprising luminescent materials A and B, and a second luminescent material comprising only A or only B, or comprising both A and B, but in a different weight ratio. Such first luminescent material and second luminescent material may have different spectral power distributions of their respective luminescent material light. Especially, in embodiments, the luminescent material may comprise at least a luminescent material of the type A3B5O12:Ce, wherein A comprises one or more of Y, La, Gd, Tb and Lu, and wherein B comprises one or more of Al, Ga, In and Sc, see also further above. Hence, in specific embodiments, the luminescent material may comprise at least two different luminescent materials configured to provide luminescent material light having different spectral power distributions; wherein the luminescent material may at least comprise a luminescent material of the type A3B5O12:Ce, wherein A comprises one or more of Y, La, Gd, Tb and Lu, and wherein B comprises one or more of Al, Ga, In and Sc.

In embodiments, the at least two different luminescent materials may, for example, be configured alternating in a circular track. In other embodiments, the at least two different luminescent materials may be configured in concentric circular tracks. In yet other embodiments, the at least two different luminescent materials may be configured in separate patches on the luminescent material arrangement. In yet other embodiments, the at least two different luminescent materials may be configured mixed together on the luminescent material arrangement.

Further, in specific embodiments the luminescent material light may have a wavelength selected from the green-red wavelength range. Here, the term “green-red wavelength range” may especially refer to the entire wavelength range green and red, and all wavelengths in between, i.e. 490-780 nm. Especially, the luminescent material may have a centroid wavelength selected from the green-red wavelength range. Herein, the terms “violet light” or “violet emission”, and similar terms, may especially relate to light having a wavelength in the range of about 380-440 nm. In specific embodiments, the violet light may have a centroid wavelength in the 380-440 nm range. The terms “green light” or “green emission”, and similar terms, may especially relate to light having a wavelength in the range of about 490-560 nm. In specific embodiments, the green light may have a centroid wavelength in the 490-560 nm range. The terms “yellow light” or “yellow emission”, and similar terms, may especially relate to light having a wavelength in the range of about 560-590 nm. In specific embodiments, the yellow light may have a centroid wavelength in the 560-590 nm range. The terms “red light” or “red emission”, and similar terms, may especially relate to light having a wavelength in the range of about 620-750 nm. In specific embodiments, the red light may have a centroid wavelength in the 620-750 nm range. The terms “cyan light” or “cyan emission”, and similar terms, especially relate to light having a wavelength in the range of about 490-520 nm. In specific embodiments, the cyan light may have a centroid wavelength in the 490-520 nm range. The phrase “light having one or more wavelengths in a wavelength range” and similar phrases may especially indicate that the indicated light (or radiation) has a spectral power distribution with at least intensity or intensities at these one or more wavelengths in the indicate wavelength range. For instance, a blue emitting solid state light source will have a spectral power distribution with intensities at one or more wavelengths in the 440-495 nm wavelength range.

The term “controlling” and similar terms especially refer at least to determining the behavior or supervising the running of an element. Hence, herein “controlling” and similar terms may e.g. refer to imposing behavior to the element (determining the behavior or supervising the running of an element), etc., such as e.g. measuring, displaying, actuating, opening, shifting, changing temperature, etc.. Beyond that, the term “controlling” and similar terms may additionally include monitoring. Hence, the term “controlling” and similar terms may include imposing behavior on an element and also imposing behavior on an element and monitoring the element. The controlling of the element can be done with a control system, which may also be indicated as “controller”. The control system and the element may thus at least temporarily, or permanently, functionally be coupled. The element may comprise the control system. In embodiments, the control system and element may not be physically coupled. Control can be done via wired and/or wireless control. The term “control system” may also refer to a plurality of different control systems, which especially are functionally coupled, and of which e.g. one control system may be a master control system and one or more others may be slave control systems. A control system may comprise or may be functionally coupled to a user interface.

The control system may also be configured to receive and execute instructions from a remote control. In embodiments, the control system may be controlled via an App on a device, such as a portable device, like a Smartphone or I-phone, a tablet, etc.. The device is thus not necessarily coupled to the lighting system, but may be (temporarily) functionally coupled to the lighting system.

The system, or apparatus, or device may execute an action in a “mode” or “operation mode” or “mode of operation” or “operational mode”. The term “operational mode may also be indicated as “controlling mode”. Likewise, in a method an action or stage, or step may be executed in a “mode” or “operation mode” or “mode of operation” or “operational mode”. This does not exclude that the system, or apparatus, or device may also be adapted for providing another controlling mode, or a plurality of other controlling modes. Likewise, this may not exclude that before executing the mode and/or after executing the mode one or more other modes may be executed.

However, in embodiments a control system may be available, that is adapted to provide at least the controlling mode. Would other modes be available, the choice of such modes may especially be executed via a user interface, though other options, like executing a mode in dependence of a sensor signal or a (time) scheme, may also be possible. The operation mode may in embodiments also refer to a system, or apparatus, or device, that can only operate in a single operation mode (i.e. “on”, without further tunability).

Hence, in embodiments, the control system may control in dependence of one or more of an input signal of a user interface, a sensor signal (of a sensor), and a timer. The term “timer” may refer to a clock and/or a predetermined time scheme. In specific embodiments, inputs for such a control system may be, next to target setting signals or boundary signals, sensor signals, such as temperature-correlated signals, optical flux correlated signals, and/or optical flux ratio or color point correlated signals, etc.

In specific embodiments, the system light may be white light. Hence, in embodiments, when controlling one or more of (i) the polarization control element, and (ii) a radiant flux of the device light, the spectral power distribution of the (white) system light may be controlled. Therefore, in specific embodiments the correlated color temperature of the system light may be controlled. Yet, in further specific embodiments the control system is configured to control a correlated color temperature of the system light in dependence of one or more of a user interface, a sensor signal, and a timer.

The term “white light”, and similar terms, herein, is known to the person skilled in the art. It may especially relate to light having a correlated color temperature (CCT) between about 1800 K and 20000 K, such as between 2000 and 20000 K, especially 2700-20000 K, for general lighting especially in the range of about 2000-7000 K, such as in the range of 2700 K and 6500 K. In embodiments, e.g. for backlighting purposes, or for other purposes, the correlated color temperature (CCT) may especially be in the range of about 7000 K and 20000 K. Yet further, in embodiments the correlated color temperature (CCT) is especially within about 15 SDCM (standard deviation of color matching) from the BBL (black body locus), especially within about 10 SDCM from the BBL, even more especially within about 5 SDCM from the BBL. The terms “visible”, “visible light” or “visible emission” and similar terms refer to light having one or more wavelengths in the range of about 380-780 nm. Herein, UV may especially refer to a wavelength selected from the range of 190-380 nm, such as 200-380 nm.

Further, the system may in embodiments comprise further optics than described above. The term “optics” may especially refer to (one or more) optical elements. Hence, the terms “optics” and “optical elements” and “optical component” may refer to the same items. The optics may include one or more or mirrors, reflectors, collimators, lenses, prisms, diffusers, phase plates, polarizers, diffractive elements, gratings, dichroics, arrays of one or more of the afore-mentioned, etc. Alternatively or additionally, the term “optics” may refer to a holographic element or a mixing rod. In embodiments, the optics may include one or more of beam expander optics and zoom lens optics. See further above for examples of optics. In embodiments, the optics may comprise an integrator, like a “Koehler integrator” (or “Köhler integrator”). In specific embodiments, the system may further comprise one or more of integrating optics, collimation optics, and homogenization optics. One or more of them are also depicted in the accompanying drawings. For example, in embodiments, the optics may comprise integrators, such as fly-eye lens array pairs or diffuser plates. Further, in embodiments, the optics may comprise such integrators in combination with further condensing and/or collimating optical components, e.g., integrating rods with a polygonal cross sectional shape such as reflective hollow integrator rods or transmissive solid integrator rods (based on total internal reflection for lateral confinement of a longitudinal propagation of the light).

The terms “upstream” and “downstream” relate to an arrangement of items or features relative to the propagation of the light from a light generating means (here the especially the light source), wherein relative to a first position within a beam of light from the light generating means, a second position in the beam of light closer to the light generating means is “upstream”, and a third position within the beam of light further away from the light generating means is “downstream”.

The light generating system may be part of or may be applied in e.g. office lighting systems, household application systems, shop lighting systems, home lighting systems, accent lighting systems, spot lighting systems, theater lighting systems, fiber-optics application systems, projection systems, self-lit display systems, pixelated display systems, segmented display systems, warning sign systems, medical lighting application systems, indicator sign systems, decorative lighting systems, portable systems, automotive applications, (outdoor) road lighting systems, urban lighting systems, green house lighting systems, horticulture lighting, digital projection, or LCD backlighting. The light generating system (or luminaire) may be part of or may be applied in e.g. optical communication systems or disinfection systems.

In yet a further aspect, the invention also provides a lamp or a luminaire comprising the light generating system as defined herein. The luminaire may further comprise a housing, optical elements, louvres, etc. etc . . . The lamp or luminaire may further comprise a housing enclosing the light generating system. The lamp or luminaire may comprise a light window in the housing or a housing opening, through which the system light may escape from the housing. In yet a further aspect, the invention also provides a projection device comprising the light generating system as defined herein. Especially, a projection device or “projector” or “image projector” may be an optical device that projects an image (or moving images) onto a surface, such as e.g. a projection screen. The projection device may include one or more light generating systems such as described herein. Hence, in an aspect the invention also provides a lighting device selected from the group of a lamp, a luminaire, a projector device, a disinfection device, a photochemical reactor, and an optical wireless communication device, comprising the light generating system as defined herein. The lighting device may comprise a housing or a carrier, configured to house or support, one or more elements of the light generating system. For instance, in embodiments the lighting device may comprise a housing or a carrier, configured to house or support one or more of the first light generating device, second light generating device, and one or more of the aforementioned optics. The lighting device may also be an automotive lighting device, such as a headlamp (or headlight) of a motorized vehicle (like a car, a truck, a bus, a coach, a tractor, a boat, an airplane, etc.).

The term “centroid wavelength”, also indicated as λc, is known in the art, and refers to the wavelength value where half of the light energy is at shorter and half the energy is at longer wavelengths; the value is stated in nanometers (nm). It is the wavelength that divides the integral of a spectral power distribution into two equal parts as expressed by the formula λc=Σλ*I(λ)/(ΣI(λ)), where the summation is over the wavelength range of interest, and I(λ) is the spectral energy density (i.e. the integration of the product of the wavelength and the intensity over the emission band normalized to the integrated intensity). The centroid wavelength may e.g. be determined at operation conditions.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 schematically depicts some embodiments of the invention;

FIG. 2-4 schematically depict some further aspects of the invention;

FIG. 5-9 schematically depict some further embodiments of the invention; and

FIG. 10 schematically depict some application embodiments. The schematic drawings are not necessarily to scale.

### DETAILED DESCRIPTION OF THE EMBODIMENTS

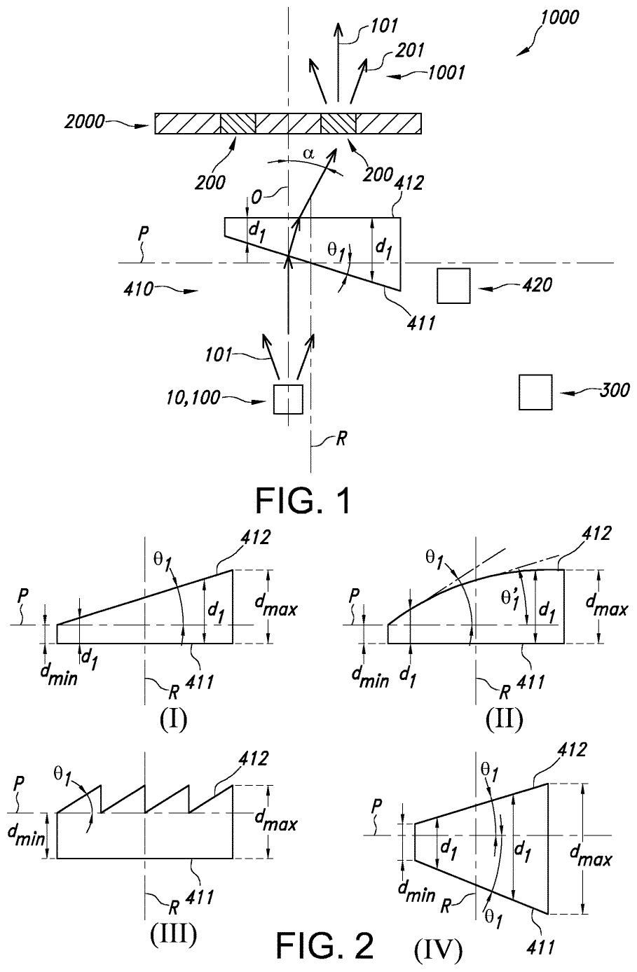

FIG. 1 schematically depicts embodiments of a light generating system 1000 comprising one or more light generating devices 100, a luminescent material arrangement 2000, a movable optical element 410, an actuator 420, and a control system 300.

Here below, the schematical drawings 1-4 are described in general, with some attention to specific drawings.

Light generating devices are herein indicated with the general reference 100. Light generating devices are configured to generate device light 101. Hence, a first light generating device 110 and a second light generating device 120 are embodiments of the light generating device 100. Likewise, first device light 111 and second device light 121 are examples of device light 101. The first light generating device 110 may also refer to a plurality of first light generating devices 110 in a laser bank. Likewise, the second light generating device 120 may also refer to a plurality of second light generating devices 120 in a laser bank. Hence, in specific embodiments, the light generating system 1000 may comprise a plurality of light generating devices 100 configured to generate device light 101, wherein two or more of the light generating devices 100 may comprise laser light sources configured in a laser bank. The one or more light generating devices 100 may be configured to generate device light 101. Therefore, in embodiments, the one or more light generating devices 100 may comprise a solid state light source 10, especially one or more of a light emitting diode, a laser diode and a superluminescent diode. In embodiments, the luminescent material arrangement 2000 may comprise a luminescent material 200. Especially, in embodiments, the luminescent material 200 may be configured to convert device light 100 received by the luminescent material 200 into luminescent material light 201.

Further, in embodiments, the movable optical element 410 may be configured to transmit at least part of the device light 101 received by the movable optical element 410. The movable optical element may, in embodiments, have an axis of rotation R. Further, in embodiments, the movable optical element 410 may comprise a first face 411 and a second face 412. In embodiments, at least one of the first face 411 and the second face 412 may have an angle θ1 relative to a plane p defined perpendicular to the axis of rotation R. In embodiments, 1°≤θ1≤44°.

Yet further, in embodiments, the actuator 420 may be configured to move the movable optical element 410, especially, via (one or more of translation and) rotation about the axis of rotation R. In embodiments, by moving the movable optical element 410 one or more of a device light spot size of the device light 101 and a device light spot position of the device light 101 on the luminescent material 200 may be controlled.

The control system 300 may therefore, in embodiments, be configured to control the actuator 420. Further, in specific embodiments, the control system 300 may be configured to control a spectral power distribution of the system light 1001 by controlling the actuator 420.

In embodiments, the light generating system may be configured to generate system light 1001 comprising one or more of the device light 101 and the luminescent material light 201. In specific embodiments, the device light 101 may comprise blue device light 101.

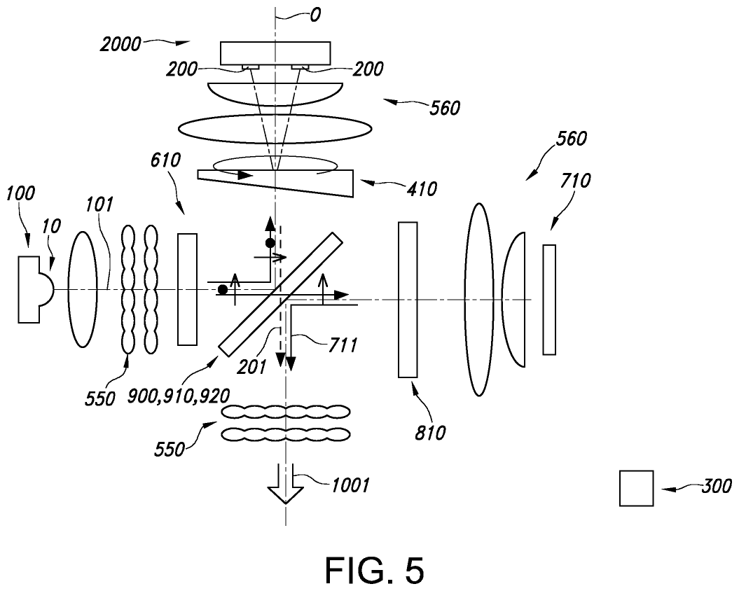

Further, in embodiments, the one or more light generating devices 100 may be configured such that device light 101 propagating to the luminescent material arrangement 2000 may have an optical axis O coinciding with the axis of rotation R of the movable optical element 410, such as depicted in FIGS. 5-9 (however, in other embodiments also in these schematically depicted embodiments the optical axis O and the axis of rotation R may not coincide). However, in other embodiments, the optical axis O and the axis of rotation R may not coincide, such as depicted in FIG. 1. Yet further, in embodiments, the movable optical element 410 and actuator 420 may be configured such that when rotating the movable optical element 410 (about the axis of rotation R) the device light spot position may have a circular or oval trajectory over the luminescent arrangement 2000.

In embodiments, the first face 411 and the second face 412 of the movable optical element 410 may define a thickness d1 of the movable optical element 410. In embodiments, the thickness d1 of the movable optical element 410 may vary over the movable optical element 410, as depicted in further detail in FIG. 2. Especially, FIG. 2 subfigure I schematically depicts an embodiment where the movable optical element 410 comprises a gradual decrease in thickness d1 over the movable optical element 410. Especially, in this embodiment, the second face 412 of the movable optical element 410 has the angle θ1 relative to the plane p. Hence, the thickness d1 gradually decreases from a maximum thickness dₘₐₓ to a minimum thickness dₘᵢₙ with a constant slope, i.e., a constant angle θ1. FIG. 2 subfigure II schematically depicts an embodiment where the movable optical element 410 comprises a gradual decrease in thickness d1 over the movable optical element 410. Especially, in this embodiment, the second face 412 of the movable optical element 410 has a plurality of local angles θ1(,θ1′, etc.) relative to the plane p. Hence, the thickness d1 gradually decreases from a maximum thickness dₘₐₓ to a minimum thickness dₘᵢₙ with a varying slope, i.e., a varying angle θ1 (,θ1′, etc.). Further, in embodiments, not depicted, the movable optical element 410 may comprise a stepwise decrease in thickness d1 over the movable optical element 410. Yet further, in embodiments such as depicted in FIG. 2 subfigure III, the movable optical element 410 may comprise a sequence of increases and decreases in thickness d1 over the movable optical element 410. Especially, in this embodiment, the second face 412 of the movable optical element 410 comprises a sequence of increases and decreases. Yet further, in embodiments such as depicted in FIG. 2 subfigure IV, the movable optical element may comprise a gradual decrease in thickness d1 over the movable optical element 410. In specific embodiments, one or more of the first face 411 and the second face 412 may comprise a radial and non-identical slope. Hence, as depicted in FIG. 2 subfigure IV, the first face 411 and the second face 412 of the movable optical element 410 may both have a radial and non-identical angle θ1 relative to the plane p. Hence, the thickness d1 gradually decreases from a maximum thickness dₘₐₓ to a minimum thickness dₘᵢₙ with a double constant slope, i.e., a double constant unequal angle θ1. As depicted in FIG. 2, the movable optical element 410 may (especially) have a wedge shape. Note that in the embodiments of FIG. 2 total angle(s) of inclination may be unequal to 0°. Referring to e.g. FIG. 2 (and FIG. 1), in embodiments it may be desirable that the axis of rotation R may be offset from the optical axis of the incident device light beam, or that in the case of a translating movable element a translation direction has a component in a direction orthogonal to the optical axis of the incident device light beam.

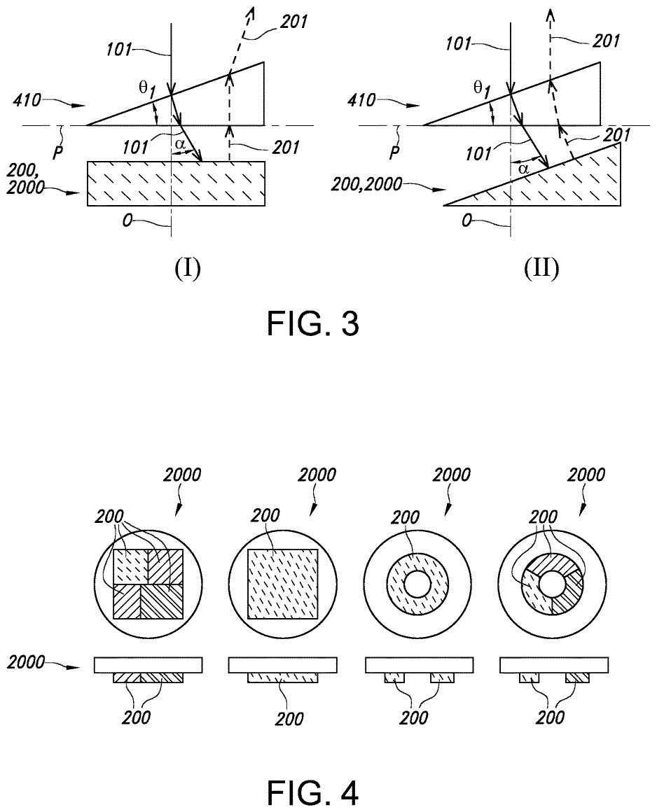

In embodiments, the luminescent material 200 may (also) comprise a sloped surface, such as depicted in FIG. 3 subfigure II. FIG. 3 especially depicts the propagation of device light 101 between the movable optical element 410 and the luminescent material arrangement 2000. The movable optical element 410 may, in embodiments, refract device light 101 incident on the first face 411 and/or the second face 412 of the movable optical element 410, such that a beam tilt may be created. Hence, the refraction caused by the first face 411 and/or the second face 412 of the movable optical element 410 may result in the beam of device light 101 (slightly) tilting away from the optical axis O. In embodiments, a tilt angle a between the optical axis O and the refracted beam of device light 101 may be created. Especially, in such embodiments, the tilt angle a may be selected from the range of 1-45°.

Additionally or alternatively, in embodiments, the luminescent material 200 of the luminescent material arrangement 2000 may have spatially varying properties selected from luminescent material concentration (not depicted) luminescent material thickness (such as in FIG. 3 subfigure II), and type of luminescent material (such as depicted in FIG. 4). Especially, FIG. 4 schematically depicts various configurations of shape and types of luminescent material 200 in the luminescent material arrangement 2000. For example, the leftmost embodiments may depict a square shaped luminescent material 200 with in one embodiment a combination of different types of luminescent material 200 and in the other embodiment a singular type of luminescent material 200. In another example, the rightmost embodiments may depict a ring shaped luminescent material 200 with in one embodiment a combination of different types of luminescent material 200 and in the other embodiment a singular type of luminescent material 200. In specific embodiments, the luminescent material 200 may be configured in thermal contact with a thermally conductive material (not depicted). Further, in specific embodiments, the luminescent material 200 may comprise at least two different luminescent materials 200 configured to provide luminescent material light 201 having different spectral power distributions. In embodiments, the luminescent material 200 at least comprises a luminescent material of the type A₃B₅O₁₂:Ce, wherein A comprises one or more of Y, La, Gd, Tb and Lu, and wherein B comprises one or more of Al, Ga, In and Sc. Especially, in embodiments, one or more of the following may apply: (a) the luminescent material 200 may be operated in the transmissive mode and the (b) the diffuser element 710 may be operated in the transmissive mode, such as depicted in FIG. 1.

Further, in embodiments, the light generating system 1000 may comprise a diffuser element 710, see (also) FIGS. 5-9. Especially, in such embodiments, the light generating system 1000 may be configured to direct in an operational mode of the light generating system 1000 part of the device light 101 to the luminescent arrangement 2000 and part of the device light 101 to the diffuser element 710. In embodiments, the diffuser element 710 may be configured to diffuse at least part of the device light 101 received by the diffuser element 710 thereby providing diffused device light 711. Hence, in such embodiments, the light generating system 1000 may be configured to generate system light 1001 comprising one or more of (device light 101,) the diffused device light 711 and the luminescent material light 201.

Referring to FIGS. 5-9, in embodiments, the light generating system 1000 may comprise a laser light engine. Especially, in embodiments, the light generating system may (further) comprise central optics 900, a polarization changing element 810, and a diffuser element 710.

FIG. 5 especially depicts embodiments of a basic configuration of the laser light engine. In embodiments, the one or more light generating devices 100 may be configured to generate polarized device light 101 having a controllable polarization. Especially, in embodiments, the control system 300 may be configured to control the polarization of the device light 101.

The light generating system 1000 may be configured to direct in an operational mode of the light generating system 1000 part of the device light 101 via the central optics 900 to the luminescent arrangement 2000 and part of the device light 101 via the central optics 900 to the diffuser element 710. Further, especially the light generating system 1000 may be configured to direct in a first operational mode of the light generating system 1000 (a) part of the device light 101 via the central optics 900 to the luminescent material arrangement 2000, and the (thus generated) luminescent material light 201 escapes from the light generating system 1000 via the central optics 900, and (b) part of the device light 101 via the central optics 900 to the diffuser element 710, and at least part of the (thus generated) diffused device light 711 escapes from the light generating system 1000 via the central optics 900. Further, in embodiments, the diffuser element 710 may be configured to diffuse (by reflection) at least part of the device light 101 received by the diffuser element 710 thereby providing diffused second device light 711 while maintaining at least part of the polarization of the device light 101. Hence, especially, in embodiments, the diffuser element 710 may be operated in the reflective mode. The polarization changing element 810 may, in embodiments, be configured in an optical path of the device light 101 between the central optics 900 and the diffuser element 710. In embodiments, the polarization changing element 810 may especially comprise one or more of a λ/4 waveplate and a Faraday rotator.

Starting with linear p-polarized light, it is converted by the polarization changing element 810 into e.g. right-handed circular pol. light, which is converted by the polarization maintaining reflective diffuser 710 into left-handed circular polarized light, which now is converted by the polarization changing element 810 into linear s-polarized light. Likewise, s-polarized light may be converted into diffused p-polarized light. Hence, device light 101 may pass the polarization changing element 810 twice, one time propagating from the central optics 900 to the diffuser element 710, and having a first polarization, and one time propagating from the diffuser element 710 to the central optics 900, being diffused at the diffuser element 900 and obtaining a second polarization when passing the polarization changing element 810 (in the direction of the central optics 900).

In embodiments, the central optics 900 may comprise (i) a central optics polarizing beam splitter 910, and (ii) a central optics dichroic beam splitter 920. In specific embodiments, the central optics polarizing beam splitter 910 may be configured to transmit and/or reflect at least part of the device light 101 in dependence of its polarization. Note this central optics polarizing beam splitter 910 may be a partial polarizing beam splitter. Further, in specific embodiments the central optics dichroic beam splitter 920 may be configured to (a) to transmit or reflect at least part of the device light 101, and (b) to reflect or transmit at least part of the luminescent material light 201. Hence, in embodiments the central optics dichroic beam splitter 920 may be configured to (a) to transmit at least part of the device light 101, and (b) to reflect at least part of the luminescent material light 201, and in other embodiments the central optics dichroic beam splitter 920 may be configured to (a) to reflect at least part of the device light 101, and (b) to transmit at least part of the luminescent material light 201. The central optics 900 may thus comprise at least two functionalities. It may be implemented as two optical components each providing one of the functions, as two functional surfaces of a single component, or as stacked functional layers on a single surface of a single component, where all previous options have the two functions still in separate functional layers, or integrated in one layer, where each “functional layer” is to be understood as a structured layer (such as a metal wire grid) or as a stack of one or more (dielectric) sub-layers.

Yet, especially the light generating system 1000 may be configured to provide system light 1001 comprising one or more of diffused second device light 711 and luminescent material light 201.

A position where system light 1001 escapes from the light generating system 1000 may also be indicated as light exit (not depicted). This may be a light transmissive window or an opening (in the system). The light transmissive window may in embodiments be provided by an optical component. Especially, reference 1001 refers to system light 1001 escaped from the system 1000.

In embodiments, the polarization control element 610 may be configured to control a degree of polarization of the polarized light. Especially, the degree of polarization may be defined as a percentage of the p-polarized light or the s-polarized light relative to the total of s-polarized light and p-polarized light. The percentages may in embodiments be based on the angular luminances of the device light with the respective polarizations.

Hence, the second device light downstream of the polarization control element may have a polarization selected from: essentially p-polarized, essentially s-polarized, and a combination of p-polarized and s-polarized. This polarization may in embodiments be controlled by rotating the polarization control element. Hence, when the polarization control element is controllable, it may have at least two polarizations e.g. selected from: essentially p-polarized, essentially s-polarized, and a combination of p-polarized and s-polarized.

In specific embodiments, the light generating system 1000 further comprises a polarization control element 610. Especially, the polarization control element 610 may be configured to control polarization of the device light 101 received by the polarization control element 610. In such embodiments, the control system 300 may be configured to control the polarization control element 610.

Further, in specific embodiments the light generating system 1000 may in addition comprise one or more of integrating optics, collimation optics, and homogenization optics. For instance, reference 560 refers to lenses, especially used for collimation of light. Reference 550 refers to integrators, which may especially be used to beam shape and homogenize light. However, further optics than schematically depicted may be available.

Working principles of the basic configuration of the light generating system 1000 (or laser-phosphor light engine), as depicted in FIG. 5: (1) An at least partially polarized high radiance light source 10, e.g. a laser light source, provides device light 101 that may be used both for contributing to the blue spectral contribution in the system light 1001 and that may be used for luminescent conversion into longer wavelength light in the cyan-red spectral range to provide broad spectrum system (white) light 1001. (2) In integrator 550, preferably a fly-eye lens array pair, may be used to homogenize the device light 101 (and by that removing the hot spot(s) in the laser beam). (3) A polarization control element (e.g. a birefringent rotator, such as a half wave plate) 610 may be used to set the ratio between the s-polarized and p-polarized light of the device light 101, with reference to the combined beam splitter 900 that may have a polarizing beam splitting functionality 910 for blue device light 101 and a dichroic beam splitting function 920 for the luminescent material light 201 versus one of the polarization components of the blue device light 101. (4) The combined beam splitter 900 may have a polarizing functionality 910 for blue device light 101, by which it may substantially reflect one polarization (i.e., the s-polarized blue device light 101) and may split the other polarization (i.e., the p-polarized device light 101) in two sizeable portions that may respectively be transmitted and reflected. (5) With setting the optical axis of the polarization control element 610 (or birefringent rotator) relative to the (main) polarization axis of the blue device light 101, the ratio of blue in the different branches may be set, enabling fine-tuning of a (white) output color point. (6) The blue PBS (polarizing beam splitter 910) and blue/yellow DBS (dichroic beam splitter 920) component 900 may not fully split the two polarizations of the incoming blue beam as may be the case with common polarizing beam splitters, but may reflect one of them (the s-pol. light) (almost) completely and may reflect the other of them (the p-pol. light) substantially (>60%) while also transmitting a substantial portion (>20%), by which a smaller fraction (<40%) of the incoming blue beam is available as contribution of blue device light 101 in the system light 1001 (or output light). (7) To enhance the maximum irradiance of the static luminescent material 200, the device light 101 may be time-sequentially spread over a larger surface area of the luminescent material 200, while instantaneously irradiating the luminescent material 200 with a smaller spot. To realize this, the by the PBS 910 reflected (pump) beam is refracted off-axis by the movable optical element 410, resulting, after passing through condenser lenses 560, in an off-axis spot on the luminescent material 200. (8) Upon rotation of the movable optical element 410, the spot on the luminescent material 200 describes a circular motion resulting in much enhanced thermal spreading and a substantially increased maximum irradiance as compared to a static pump spot on a static luminescent material 200. (9) The luminescent material 200 may be shaped as a plate or ring, it may comprise a single luminescent material 200 or multiple luminescent materials 200, may have a flat surface or a surface varying in thickness relative to the incident blue beam, and may be a single continuous area or may comprise multiple segments with at least partly different luminescent characteristics. (10) The (reflective mode) luminescent material light 201 may be collected by the condenser lenses 560 and transmitted through the (blue PBS 910 and) yellow-blue DBS 920 to the output. (11) The transmitted blue (p-pol.) device light 101 may pass the polarization changing element 810 (e.g. a λ/4 plate) and may be projected via condenser lenses 560 onto a preferably polarization maintaining diffuser 710. (12) The (reflective mode) diffused blue device light 711 may be collected by the condenser lenses 560 and may pass again the polarization changing element 810 (by which it becomes substantially s-pol. light), upon which it may be predominantly reflected at the blue PBS 910 (and blue-yellow DBS 920) (i.e., the diffused s-pol. device light 711 may substantially reflected, while diffused p-pol. device light 711 may be substantially reflected), and as a result this diffused blue device light 711 may be combined with the luminescent material light 201 into (white) system light 1001. (13) An optional integrator 550 is used to further homogenize the white system light 1001.

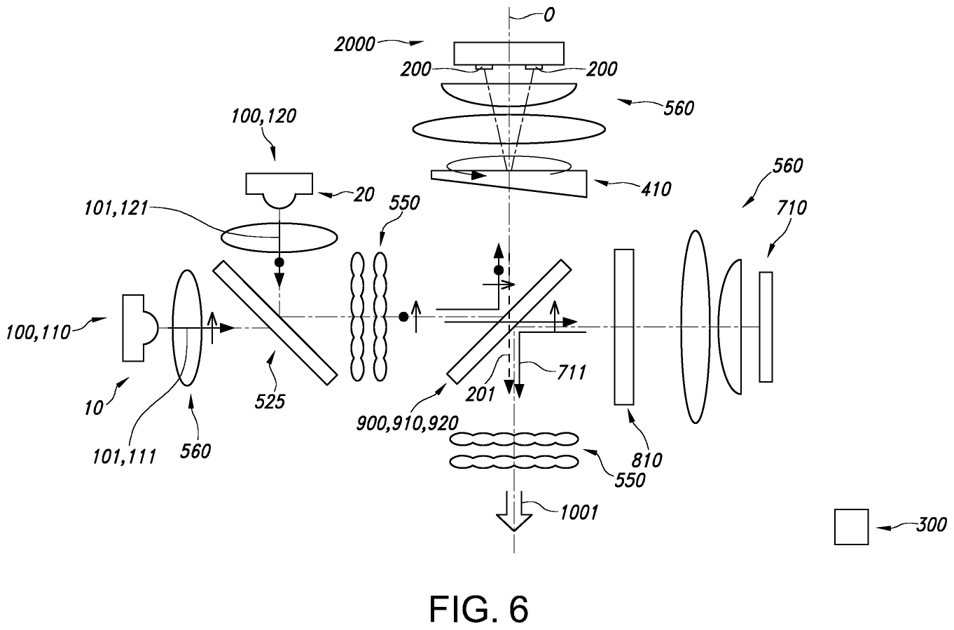

In specific embodiments, such as depicted in FIG. 6, the one or more light generating devices may comprise two different types of light generating devices 100, differing in the type of polarization of the device light 101 they generate. In such embodiments, the light generating system 1000 may further comprise a first polarizing beam splitter 525. The first polarizing beam splitter 525 may be configured downstream of the two different types of light generating devices 100 and upstream of the central optics 900. In embodiments, the first polarizing beam splitter 525 may be configured to transmit s-polarized light or p-polarized light, and to reflect p-polarized light or s-polarized light. In such embodiments, the control system 300 may be configured to control the two different types of light generating devices 100.

Referring to FIG. 6, the output of two laser light sources 10,20 may be configured via a first polarizing beam splitter 525 to provide a targeted ratio of s/p-polarized device light 101 that may be split by a combined dichroic beam splitter (DBS 920) and partially polarizing beam splitter (PBS 910). Working principles of this configuration of the light generating system 1000 (or laser-phosphor light engine): (1) To enhance the irradiance of the luminescent material 200 and the maximum light engine output flux, two laser beams with complementary polarization (e.g. s- and p-polarization) may be combined via a first polarizing beam splitter 525. (2) The combined beam may be homogenized and input to a combined polarizing beam splitter 910 and dichroic beam splitter 920 component 900. (3) The ratio of s- vs p-polarized device light 101 that may be incident on the combined polarizing beam splitter 910 and dichroic beam splitter 920 component 900 may be adjusted by setting the output power ratio of the two light sources (and not via a polarization control element 610). (4) The further splitting, converting, diffusing, and combining functions are the same as described with the single-source configuration of FIG. 5, except that the polarizing beam splitting characteristics (requirements) of the combined polarizing beam splitter 910 and dichroic beam splitter 920 component 900 may be somewhat different from that of the combined polarizing beam splitter 910 and dichroic beam splitter 920 component 900 of the single-source configuration.

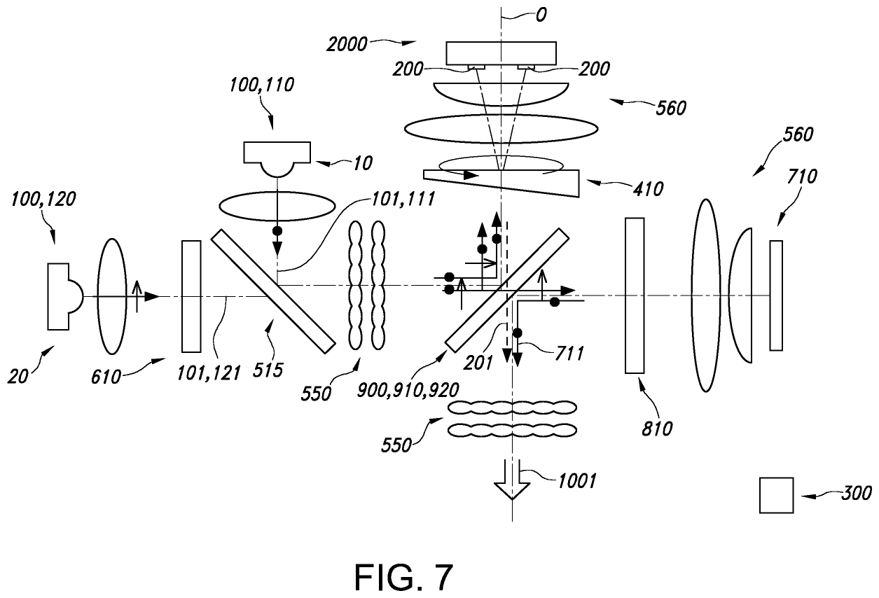

In specific embodiments, such as depicted in FIG. 7, the one or more light generating devices may comprise two different types of light generating devices 100, differing in a spectral power distribution of the device light 101 they generate. Further, the light generating system 1000 may comprise a first dichroic beam splitter 515. The first dichroic beam splitter 515 may be configured downstream of the two different types of light generating devices 100 and upstream of the central optics 900. In embodiments, the first dichroic beam splitter 515 is configured (a) to transmit or reflect at least part of the device light 101 of a first type, and (b) to reflect or transmit at least part of the device light 101 of a second type. In such embodiments, the control system 300 may be configured to control the two different types of light generating devices 100. Referring to FIG. 7, the output of two laser light sources 10,20 is configured via a first dichroic beam splitter 515 to provide a targeted ratio of light with a first and a second wavelength that is split by a combined dichroic beam splitter (DBS 920) and partially polarizing beam splitter (PBS 910).

Working principles of this configuration of the laser-phosphor light engine: (1) In this embodiment, two laser (array) light sources 10,20 may be used that may emit device light 101 (at least partly) at different wavelengths that may be combined via a first dichroic beam splitter 515. (2) The shortest wavelength blue device light 101 may be used as the s-polarized light as referenced to the combined polarizing beam splitter 910 and dichroic beam splitter 920 component 900. (3) The longest wavelength blue device light 101 may be provided with a polarization control element 610 (e.g. a birefringent rotator) to enable adjustment of its s/p polarization ratio when incident on the combined polarizing beam splitter 910 and dichroic beam splitter 920 component 900. In this way, the longer wavelength blue device light 101 may be used as the (dominant) blue component in the output white system light 1001, providing improved color quality relative to when using the shorter wavelength blue device light 101 for this, while both wavelengths may be used to pump the one or more luminescent materials 200. (4) With setting the optical axis of a polarization control element 610 relative to the (main) polarization axis of the blue device light 101, the ratio of blue device light 101 in the different branches may be set, and by that the ratio of diffused blue device light 101 to luminescent material light 201, enabling fine-tuning of the resulting (white) system light 1001 color point. (5) The blue PBS (polarizing beam splitter 910) and blue/yellow DBS (dichroic beam splitter 920) component 900 may not fully split the two polarizations of the incoming blue device light 101, as may be the case with common polarizing beam splitters, but may reflect one of them (the s-polarized blue device light 101) (almost) completely and may both reflect and transmit the other of them (p-polarized blue device light 101) substantially (>40% transmittance, >20% reflectance). (6) The reflected blue device light 101 may be projected onto the luminescent material 200 via the movable optical element 410; this luminescent material 200 may comprise a single luminescent material 200, a mixture of luminescent materials 200(,210,220,) and/or multiple segments with different luminescent characteristics, and may be plate or ring shaped. (7) The luminescent material light 201 may be collected and transmitted through the (blue PBS 910 and) yellow-blue DBS2 920 to the output. (8) The PBS-transmitted blue (p-pol.) device light 101 may be passing a polarization changing element 810 (e.g. a λ/4 plate) and may be projected onto a preferably polarization maintaining diffuser 710. (9) The diffused blue device light 711 may be collected and may pass again the polarization changing element 810 by which it may become s-pol. Diffused device light 711, which may predominantly be reflected at the PBS 910 (i.e., the diffused s-pol. device light 711 may be (almost) completely reflected, and the diffused p-pol. device light 711 may be substantially reflected), upon which this diffused blue device light 711 may be combined with the luminescent material light 201 into (white) system light 1001. (10) An optional integrator 550 may be used to further homogenize the white system light 1001.

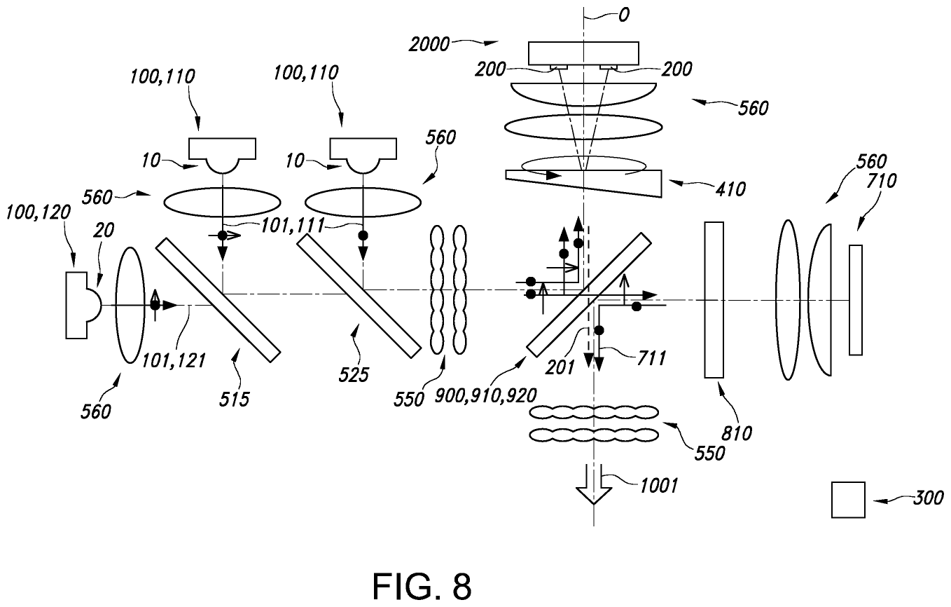

Referring to FIG. 8, the first dichroic beam splitter 515 and the first polarizing beam splitter 525 may be employed together to provide a targeted ratio of light with a first and a second wavelength and with a p/s polarization that may be split by a combined dichroic beam splitter (DBS) 920 and partially polarizing beam splitter (PBS) 910. Working principles of this configuration of the light generating system 1000 (or laser-phosphor light engine): (1) In this embodiment, three laser (array) light generating devices 100 (110,120,130, respectively) may be used that may emit device light 101 (111,121,131, respectively) (at least partly) at different wavelengths and (partly) with different polarization, and that may be combined via a first dichroic beam splitter 515 and a first polarizing beam splitter 525. (2) First device light 111 and second device light 121 with, respectively, a first and a (different) second emission wavelength may be combined via first dichroic beam splitter 515, and may be configured to provide p-polarized light when incident on the first polarizing beam splitter 525 (and the combined polarizing beam splitter 910 and dichroic beam splitter 920 component 900). (3) The polarization of the third device light 131, which may emit at the first, the second, or at a different, third, wavelength, may be configured as s-polarized device light 101. (4) The third device light 131 may be combined with the first and second device light 111,121 via the first polarizing beam splitter 525. (5) Adjustment of the color point of the system light 1001 may be realized by changing the output power ratio of the light generating devices 100, in particular the ratio of the third device light 131 output power relative to that of the sum of the first and second device light 111,121. (6) The further light beam homogenization, splitting, dynamic refraction to off-axis positions via a rotating optical wedge, luminescent conversion, polarization conversion, reflective diffusion and beam combining may be comparable to the system described previously.

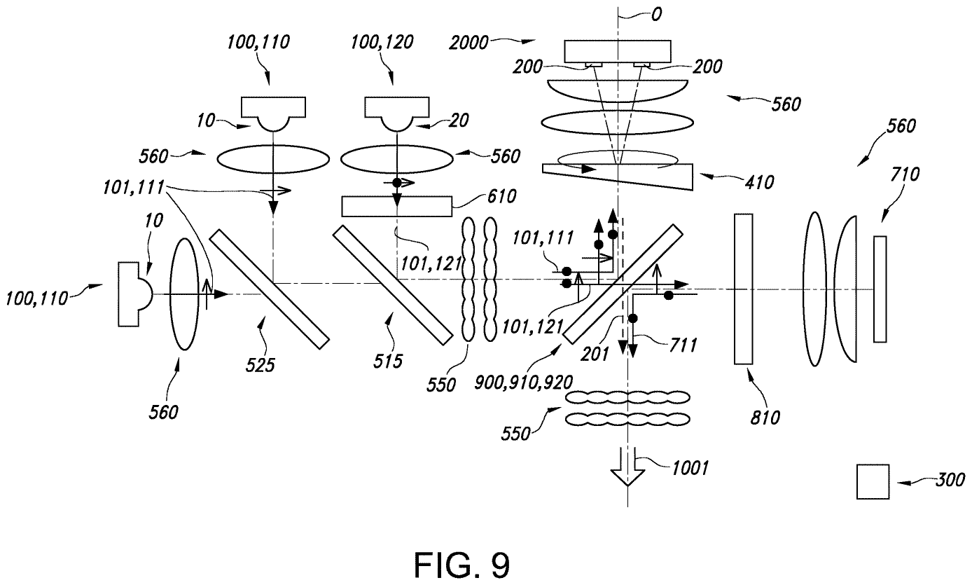

Referring to FIG. 9, the first dichroic beam splitter 515 and the first polarizing beam splitter 525 may be employed together but in reversed order relative to the configuration in FIG. 8. Working principles of this configuration of the light generating system 1000 (or laser-phosphor light engine): (1) In this embodiment, three laser (array) light generating devices 100 may be used that emit (at least partly) at different wavelengths and (partly) with different polarization, and that may be combined via a first dichroic beam splitter 515 and a first polarizing beam splitter 525. (2) First device light 111 from two first light generating devices 110 with the same, first, emission wavelength may be combined via the first polarizing beam splitter 525. (3) The polarization of the second device light 121, which may emit at a different, second, wavelength, may be set via rotation of the optical axis of polarization control element 610 (e.g. a birefringent rotator); by this the ratio of blue device light 101 to luminescent material light 201 in the system light 1001 may be adjusted. (4) The second wavelength device light 121, after having set its polarization state, may be combined with the first wavelength device light 111 via the first dichroic beam splitter 515. (5) The further light beam homogenization, splitting, dynamic refraction to off-axis positions via a rotating optical wedge, luminescent conversion, polarization conversion, reflective diffusion and beam combining may be comparable to the system described previously.

It may be obvious that multiple other permutations of building blocks/subsystems as presented so far are covered as further embodiments according to the principles of this invention as well. As an example, the combination of two laser beams, that have been configured to have orthogonal polarization, via a first polarizing beam splitter 525 (as described in FIG. 6 for one specific configuration) is applicable to all other embodiments presented here as well. Obviously, such orthogonality of the polarization of the beams from two laser (array) sources may be achieved by using a retarder in front of one of the sources.

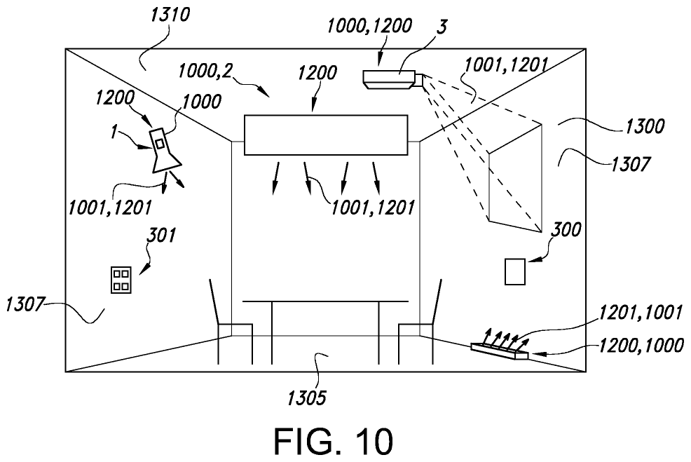

FIG. 10 schematically depicts an embodiment of a luminaire 2 comprising the light generating system 1000 as described above. Reference 301 indicates a user interface which may be functionally coupled with the control system 300 comprised by or functionally coupled to the light generating system 1000. FIG. 10 also schematically depicts an embodiment of lamp 1 comprising the light generating system 1000. Reference 3 indicates a projector device or projector system, which may be used to project images, such as at a wall, which may also comprise the light generating system 1000. Hence, FIG. 10 schematically depicts embodiments of a lighting device 1200 selected from the group of a lamp 1, a luminaire 2, a projector device 3, a disinfection device, a photochemical reactor, and an optical wireless communication device, comprising the light generating system 1000 as described herein. In embodiments, such lighting device may be a lamp 1, a luminaire 2, a projector device 3, a disinfection device, or an optical wireless communication device. Lighting device light escaping from the lighting device 1200 is indicated with reference 1201. Lighting device light 1201 may essentially consist of system light 1001, and may in specific embodiments thus be system light 1001. Reference 1300 refers to a space, such as a room. Reference 1305 refers to a floor and reference 1310 to a ceiling; reference 1307 refers to a wall.

The term “plurality” refers to two or more. The terms “substantially” or “essentially” herein, and similar terms, will be understood by the person skilled in the art. The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%. The term “comprise” also includes embodiments wherein the term “comprises” means “consists of”. The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, apparatus, or systems may herein amongst others be described during operation. As will be clear to the person skilled in the art, the invention is not limited to methods of operation, or devices, apparatus, or systems in operation.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

Use of the verb “to comprise” and its conjugations does not exclude the presence of elements or steps other than those stated in a claim. Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage. In yet a further aspect, the invention (thus) provides a software product, which, when running on a computer is capable of bringing about (one or more embodiments of) the method as described herein.

The invention also provides a control system that may control the device, apparatus, or system, or that may execute the herein described method or process. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. A light generating system comprising (i) one or more light generating devices, (ii) a luminescent material arrangement, (iii) a movable optical element, (iv) an actuator, and (v) a control system, wherein:
the one or more light generating devices are configured to generate device light; wherein the one or more light generating devices comprise one or more of a laser diode and a superluminescent diode;
the luminescent material arrangement comprises a luminescent material configured to convert at least part of the device light received by the luminescent material into luminescent material light;
the movable optical element is configured to transmit at least part of the device light received by the movable optical element, wherein the movable optical element has an axis of rotation, wherein the movable optical element comprises a first face and a second face, wherein at least one of the first face and the second face has an angle relative to a plane defined perpendicular to the axis of rotation, wherein 1°≤θ1≤44°;
the actuator is configured to move the movable optical element via rotation about the axis of rotation, whereby one or more of a device light spot size of the device light and a device light spot position of the device light on the luminescent material is controlled;
the control system is configured to control the actuator; and
the light generating system is configured to generate system light comprising one or more of the device light and the luminescent material light,
the light generating system further comprising central optics, a polarization changing element, and a diffuser element, wherein:
the one or more light generating devices are configured to generate polarized device light having a controllable polarization;
the light generating system is configured to direct in an operational mode of the light generating system part of the device light via the central optics to the luminescent arrangement and part of the device light via the central optics to the diffuser element;
the diffuser element is configured to diffuse at least part of the device light received by the diffuser element thereby providing diffused device light while maintaining at least part of the polarization of the device light;
the polarization changing element is configured in an optical path of the device light between the central optics and the diffuser element;
the central optics comprises (i) a central optics polarizing beam splitter, and (ii) a central optics dichroic beam splitter; wherein the central optics polarizing beam splitter is configured to transmit and/or reflect at least part of the device light in dependence of its polarization; and wherein the central optics dichroic beam splitter is configured (a) to transmit or reflect at least part of the device light, and (b) to reflect or transmit at least part of the luminescent material light;
the control system is configured to control the polarization of the device light; and
the light generating system is configured to generate system light comprising one or more of the diffused device light and the luminescent material light.

2. The light generating system according to claim 1, wherein the first face and the second face of the movable optical element define a thickness of the movable optical element, wherein the thickness of the movable optical element varies over the movable optical element, wherein the movable optical element comprises a gradual decrease in thickness over the movable optical element, a stepwise decrease in thickness over the movable optical element, or a sequence of increases and decreases in thickness over the movable optical element.

3. The light generating system according to claim 1, wherein the one or more light generating devices are configured such that device light propagating to the luminescent arrangement has an optical axis coinciding with the axis of rotation of the movable optical element.

4. The light generating system according to claim 1, wherein (i) one or more of the first face and the second face comprise a radial slope, or (ii) wherein both the first face and the second face comprise radial slopes, wherein the radial slopes are not identical.

5. The light generating system according to claim 1, wherein the movable optical element has a wedge shape.

6. The light generating system according to claim 1, wherein the movable optical element and actuator are configured such that when rotating the movable optical element the device light spot position has a circular or oval trajectory over the luminescent material arrangement.

7. The light generating system according to claim 1, wherein the luminescent material of the luminescent material arrangement has spatially varying properties selected from luminescent material concentration, luminescent material thickness, and type of luminescent material.

8. The light generating system according to claim 7, wherein the control system is configured to control a spectral power distribution of the system light by controlling the actuator.

9. The light generating system according to claim 1, further comprising a diffuser element, wherein the light generating system is configured to direct in an operational mode of the light generating system part of the device light to the luminescent arrangement and part of the device light to the diffuser element; wherein the diffuser element is configured to diffuse at least part of the device light received by the diffuser element thereby providing diffused device light; and wherein the light generating system is configured to generate system light comprising one or more of the diffused device light and the luminescent material light.

10. The light generating system according to claim 1, wherein one or more of the following applies: (a) the luminescent material is operated in the transmissive mode and the (b) the diffuser element is operated in the transmissive mode.

11. The light generating system according to claim 1, wherein one or more of the following applies:
(a) the light generating system further comprises a polarization control element, wherein the polarization control element is configured to control polarization of the device light received by the polarization control element; and wherein the control system is configured to control the polarization control element; and
(b) the one or more light generating devices comprise two different types of light generating devices, differing in the type of polarization of the device light they generate; wherein the light generating system further comprises a first polarizing beam splitter, wherein the first polarizing beam splitter is configured downstream of the two different types of light generating devices and upstream of the central optics; and wherein the first polarizing beam splitter is configured to transmit p-polarized light, and to reflect s-polarized light; and wherein the control system is configured to control the two different types of light generating devices.

12. The light generating system according to claim 1, wherein the one or more light generating devices comprise two different types of light generating devices, differing in a spectral power distribution of the device light they generate; wherein the light generating system further comprises a first dichroic beam splitter, wherein the first dichroic beam splitter is configured downstream of the two different types of light generating devices and upstream of the central optics; wherein the first dichroic beam splitter is configured (a) to transmit or reflect at least part of the device light of a first type, and (b) to reflect or transmit at least part of the device light of a second type; wherein the control system is configured to control the two different types of light generating devices.

13. The light generating system according to claim 1, wherein the luminescent material is configured in thermal contact with a thermally conductive material; wherein the light generating system comprises a plurality of light generating devices configured to generate the device light, wherein two or more of the light generating devices comprise laser light sources configured in a laser bank; wherein the light generating system further comprises one or more of integrating optics, collimation optics, and homogenization optics; wherein the luminescent material comprises at least two different luminescent materials configured to provide luminescent material light having different spectral power distributions; wherein the luminescent material at least comprises a luminescent material of the type A₃B₅O₁₂:Ce, wherein A comprises one or more of Y, La, Gd, Tb and Lu, and wherein B comprises one or more of Al, Ga, In and Sc; and wherein the device light comprises blue device light.

14. The light generating system according to claim 1, wherein the polarization changing element comprises one or more of a λ/4 waveplate and a Faraday rotator.

15. A lighting device selected from the group of a lamp, a luminaire, a projector device, a disinfection device, a photochemical reactor, an automotive lighting device, and an optical wireless communication device, comprising the light generating system according to claim 1.
